(19) United States
(12) Patent Application Publication
(10) Pub. No.: US 2025/0315423 A1
(43) Pub. Date: Oct. 9, 2025

(54) SYSTEMS AND METHODS FOR VARIABLY SCOPED, DATA-DEPENDENT READ SNAPSHOTS

(71) Applicant: Cockroach Labs, Inc., New York, NY (US)

(72) Inventors: Nathan J. VanBenschoten, Brooklyn, NY (US); Spencer Kimball, New York, NY (US); Andrei Matei, Brooklyn, NY (US)

(21) Appl. No.: 18/626,908

(22) Filed: Apr. 4, 2024

(51) Int. Cl. G06F 16/23

(52) U.S. Cl. CPC G06F 16/2322; G06F 16/2329

(57) ABSTRACT

Systems and methods for controlling execution of conflicting transactional operations are provided. A first transaction comprising (i) a first request directed to first data of a first partition stored by a plurality of computing nodes and (ii) a first timestamp is received from a client device. A refresh span list configured to indicate data read by the first transaction is generated. Based on the first data being associated with a second timestamp greater than the first timestamp, a conflict associated with the first transaction is identified. Based on the conflict, a refresh timestamp greater than or equal to the second timestamp is determined. Based on the refresh span list, the first transaction is committed at the refresh timestamp.

### FIELD OF TECHNOLOGY

The present disclosure relates generally to methods and systems for controlling transactional operations of a distributed system and more particularly, to controlling execution of conflicting transactional operations of a distributed system.

### BACKGROUND

In some cases, relational databases can apply replication to ensure data survivability, where data is replicated among one or more computing devices (“nodes”) of a group of computing devices (“cluster”). A relational database may store data within one or more ranges, where a range can include one or more key-value (KV) pairs and can be replicated among one or more nodes of the cluster. A range may be a partition of a data table (“table”), where a table may include one or more ranges. The database may receive requests (e.g., such as read or write requests originating from client devices) directed to data and/or schema objects stored by the database.

In some cases, a transaction operating on a database can operate with particular requirements for correctness based on a configured isolation level of the transaction. An isolation level can define how and when modification(s) (e.g., to data) made by a transaction can become visible by other transactions operating on the database. In some cases, strong isolation levels can provide a high degree of isolation between concurrent (e.g., simultaneously executing) transactions, such that they limit and/or eliminate types of concurrency effects that transactions may observe. Weak isolation levels can be more permissive than strong isolation levels, thereby trading isolation guarantees for improved performance (e.g., improved transaction latency). Transactions operating on a database configured with weaker isolation levels can block less and experience fewer aborts (e.g., retry errors) relative to transactions operating on a database configured with stronger isolation levels. In some systems, operating on a database configured with weaker isolation levels can be less work. Some examples of isolation levels ordered from a weakest isolation to a strongest isolation level can include: a read uncommitted isolation level, a read committed isolation level, a snapshot isolation level, and a serializable isolation level.

In some cases, a database system using multi-version concurrency control (MVCC) can make use of consistent snapshots of the database at a particular instants in time (e.g., defined by timestamps). A consistent snapshot of the database can guarantee that read operations (e.g., derived from statements in a transaction that cause reads of data) will observe (i) the latest committed values of the database at the instant in time of the snapshot, and (ii) no values committed after the instant in time of the snapshot. Combined with the atomicity property of atomic, consistent, isolated, and durable (ACID) transactions, consistent snapshots of a database can be guaranteed to include (i) either all or none of the write operations (e.g., derived from statements in a transaction that cause writes of data) executed by any given committed transaction, and (ii) none of the write operations performed by any given aborted transaction.

Further, a database system using MVCC can map isolation levels onto multiple read snapshots having different scopes. A scope of a read snapshot (also referred to as a “read snapshot scope”) can define a scope within a transaction, where the read operations (e.g., read requests) in the transaction present a consistent snapshot of the database (e.g., to an application operating at a client device). As an example, a relatively weak isolation level such as read committed isolation may provide a “per-statement” read snapshot scope, which can be defined by providing read snapshot scopes for each transactional (e.g., structured query language (SQL)) statement of a transaction including one or more transactional statements, while allowing different transactional statements of the transaction to read from different read snapshots. Such an isolation level can lead to concurrency anomalies including non-repeatable reads. Meanwhile, a stronger isolation level such as a snapshot isolation level may provide a “per-transaction” read snapshot scope, which can be defined by providing a single read snapshot scope for an entire transaction (e.g., SQL transaction) including one or more transactional statements, thereby eliminating some concurrency anomalies.

In some cases, transaction conflicts can occur during execution of read requests and/or write requests of different transactions. A first request of a first transaction may encounter and conflict with a second request of a second transaction, thereby necessitating the first transaction use a new, updated read snapshot in place of a previous read snapshot used by the first transaction. The previous read snapshot may be unsuitable for use by the first transaction for reasons including isolation conflicts and consistency conflicts. In some cases, an isolation conflict can refer to a conflict between concurrent transactions, where the conflict can cause (e.g., lead to) at least one anomaly that is prohibited by an isolation level corresponding to the concurrent transactions. For a write/write conflict, two concurrent transactions can both attempt to execute a write request for data (e.g., for a KV, a row of a table, etc.). When neither of the concurrent transactions' read scopes contains (e.g., data written by) the other transaction's write request, such a conflict can cause a lost update anomaly.

In some cases, for transactions having a snapshot isolation level or a serializable isolation level, the transactions each retain a single read snapshot for all of the statements included in the respective transaction. For such transactions, a write/write conflict can be unsafe when two concurrent transactions both execute a read operation for an initial version of data (e.g., using SELECT statements) and then both proceed to execute a write operation (e.g., via an UPDATE statement) to the data without considering the other transaction's write operation, as the second write operation may execute without accounting for the modification to the data made by the first write operation. In some cases, for transactions having a read committed isolation level, the transactions each retain a new read snapshot for each of the statements of the respective transaction. Based on two concurrent transactions executing write operations (e.g., via UPDATE statements) and the write operations involving reading an initial version of data, the transactions can both write to the data without considering the other transaction's write operation.

Further, for a read/write conflict, a first transaction can execute a read operation for first data and a second transaction can later execute a write operation to the first data and commit. When the first transaction then writes to different, second data and commits, the database storing the first and second data may be altered to an unexpected and/or unintended state based on the non-serializable interleaving of read operations and write operations. For example, a read/write conflict may cause a write skew anomaly. While most isolation levels allow a write skew anomaly to occur in a database, a serializable isolation level prohibits a write skew anomaly.

In some cases, a database can detect and identify both write/write and read/write conflicts based on a configured isolation level of the database. Based on detecting a particular conflict between two concurrent transactions, the database can abort and retry a current operation of one of the concurrent transactions. Aborting a current operation of one of the concurrent transactions can include retrying at a level of the read snapshot scope (e.g., per-transaction or per-statement) for the transactional isolation level of the database. For a per-transaction read snapshot scope, aborting a current operation of one of the concurrent transactions can include aborting the transaction and retrying execution of the transaction. For a per-statement read snapshot scope, aborting a current operation of one of the concurrent transactions can include aborting the current statement of the transaction and retrying execution of the statement of the transaction.

In some cases, a consistency conflict can relate to a conflict between two concurrent transactions, which can permit one of the transactions to violate real-time ordering guarantees of a database of a distributed system (e.g., distributed database system). An example of a consistency conflict that can occur in a distributed system is an uncertain read conflict, where the distributed system is configured to provide (e.g., at least) read-after-write consistency. In some cases, read-after-write consistency can guarantee that a second transaction which starts (e.g., begin to execute) after a first transaction commits (e.g., in real time) can read the values written by the first transaction (e.g., when the values have not been overwritten by a different, third transaction). A distributed system can make use of loosely-synchronized clocks (e.g., hybrid-logical clocks (HLCs)) operating at computing devices of the distributed system, where the clocks have a synchronization error bound configured to provide such a guarantee. Because the clocks are not perfectly synchronized, a first clock operating at a first computing device can lead or lag a second clock operating at a second computing device. As a result, a first transaction may commit with a first timestamp on a first computing device (e.g., having a relatively faster clock) and a later, second transaction may begin with a read snapshot at a second timestamp on a second computing device (e.g., having a relatively slower clock), where the first timestamp is greater than the second timestamp. Consequently, transactions cannot rely solely on timestamp ordering between committed writes and read snapshots to provide read-after-write consistency, else the second transaction would fail to read the write from the first transaction.

In some cases, a transaction may encounter data written by a committed write operation outside of the transaction's current read snapshot, where the transaction cannot be certain the data did not, in real time, get written before the read snapshot was taken. In such cases, the transaction may be required to abort the current operation and establish a new read snapshot at a later timestamp that observes the uncertain data. For a read committed isolation level, execution of the statement corresponding to the aborted operation may be retried, and for a snapshot isolation level and a serializable isolation level, execution of the entire transaction may be retried.

Thus, isolation conflicts and consistency conflicts can cause (i) aborts and retries for a statement of a transaction, and/or (ii) aborts and retries for an entire transaction (e.g., all statements included in the transaction). Such aborts and retries are problematic for a database (e.g., operating on a distributed system) and an application (e.g., operating on a client device) due to wasting work performed by the database and the application, increasing transaction latency, and reducing system throughput. Further, aborts of transactions can cause the database to send errors to the application from which the transactions originate, where the errors can cause the application to rerun the logic of the entire transaction. An application may be prepared to perform this retry of the entire transaction by resending the transaction logic to the database. Accordingly, improved systems and methods for controlling execution of transactions at a database are desired that can avoid aborts and retries of statement(s) of the transactions when encountering conflicts (e.g., isolation conflicts and/or consistency conflicts) during transaction execution.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

Methods and systems for controlling execution of conflicting transactional operations are disclosed. In one aspect, embodiments of the present disclosure feature a computer-implemented method for controlling execution of conflicting transactional operations. According to one embodiment, the method includes receiving, from a client device by a computing node of a plurality of computing nodes, a first transaction including (i) a first request directed to first data of a first partition stored by the plurality of computing nodes and (ii) a first timestamp, where the computing node generates a refresh span list configured to indicate data read by the first transaction; identifying, based on the first data being associated with a second timestamp greater than the first timestamp, a conflict associated with the first transaction; determining, based on the conflict, a refresh timestamp greater than or equal to the second timestamp; and committing, based on the refresh span list, the first transaction at the refresh timestamp.

Various embodiments of the method can include one or more of the following features. The computing node may assign the first timestamp to the first transaction, where the first timestamp is equal to a time at which the computing node received the first transaction. The first request may be configured to read a most recent version of the first data having a timestamp less than or equal to the first timestamp. The first request may be configured to write a new version of the first data having the first timestamp. The computing node may be configured to record an indication of a version of data read by the first transaction in the refresh span list. In some variations, the first data can include key-value data and the first partition can include a plurality of versions (e.g., MVCC versions) of the key-value data.

In some embodiments, the first transaction can include a second request configured to read a most recent version of second data of a second partition stored by the plurality of computing nodes, the most recent version of the second data having a timestamp less than or equal to the first timestamp, where the first request can be configured to write a new version of the first data having the first timestamp. In some variations, identifying the conflict associated with the first transaction can include determining the first data was written at the second timestamp; comparing the first timestamp to the second timestamp; based on the second timestamp being greater than or equal to the first timestamp, identifying the conflict; and determining, based on identifying the conflict, the refresh timestamp is greater than the second timestamp. In some variations, identifying the conflict associated with the first transaction can include determining the first data was read by a second transaction at the second timestamp; comparing the first timestamp to the second timestamp; based on the second timestamp being greater than or equal to the first timestamp, identifying the conflict; and determining, based on identifying the conflict, the refresh timestamp is greater than the second timestamp.

In some variations, the first transaction can include a second request configured to read a most recent version of second data of a second partition stored by the plurality of computing nodes, the most recent version of the second data having a third timestamp less than or equal to the first timestamp, where the first request can be configured to write a new version of the first data having the first timestamp. In some variations, identifying the conflict associated with the first transaction can include writing, by the first request, the new version of the first data, where the new version of the first data is uncommitted; identifying, by a second transaction, the first timestamp of the new version of the first data, where the second transaction includes a third request configured to read a most recent version of the first data having a fourth timestamp less than or equal to the second timestamp; comparing the first timestamp to the second timestamp, based on the second timestamp being greater than or equal to the first timestamp, identifying the conflict; and determining, based on identifying the conflict, the refresh timestamp is greater than the second timestamp.

In some embodiments, the first request can be configured to read a most recent version of the first data having a timestamp less than or equal to the first timestamp. In some variations, identifying the conflict associated with the first transaction can include determining a version of the first data has the second timestamp; determining the second timestamp is (i) greater than the first timestamp and (ii) within an uncertainty interval of the first transaction; based on the second timestamp being (i) greater than the first timestamp and (ii) within the uncertainty interval of the first transaction, identifying the conflict; and determining, based on identifying the conflict, the refresh timestamp is greater than or equal to the second timestamp. The method may further include sending, based on determining the refresh timestamp, (i) the refresh timestamp and (ii) an indication of the conflict to the computing node. The method may further include receiving, from the computing node based on the refresh span list, at least one refresh request includes an indication of third data of a third partition stored by the plurality of computing nodes, where the first transaction previously read a most recent version of the third data having a third timestamp less than or equal to the first timestamp. The method may further include updating (e.g., advancing) the first timestamp to be equal to the refresh timestamp based on determining each version of the third data includes a respective timestamp that is (i) less than or equal to the first timestamp or (ii) greater than the refresh timestamp.

In some variations, the first request can include an indicator including a value that is selected (i) based on the refresh span list and (ii) by the computing node. The method may further include updating, based on determining the refresh timestamp and a value of the indicator, the first timestamp to be equal to the refresh timestamp. In some variations, committing the first transaction can include reading a most recent version of the first data having a timestamp less than or equal to the refresh timestamp. The first request may be configured to write a new version of the first data, and committing the first transaction can include writing the new version of the first data having the refresh timestamp. In some variations, a timestamp data structure (e.g., timestamp cache) can indicate the first data was read by the second transaction at the second timestamp. In some variations, the uncertainty interval can be configured based on a maximum allowed timestamp difference between a plurality of clocks operated by the plurality of computing nodes. The method may further include committing, based on updating the first timestamp to be equal to the refresh timestamp, the first transaction at the refresh timestamp. In some variations, (i) the indicator has a first value when the refresh span list indicates the first transaction has executed at least one read request of the first transaction, and (ii) the indicator has a second value when the refresh span list indicates the first transaction has not executed any read request of the first transaction. In some variations, (i) the indicator has a first value when the refresh span list indicates the first transaction has executed at least one read request of an individual statement of the first transaction, and (ii) the indicator has a second value when the refresh span list indicates the first transaction has not executed any read request of the individual statement of the first transaction.

In another aspect, the present disclosure features a system for controlling execution of conflicting transactional operations. The system can include corresponding computer systems (e.g., servers), apparatus, and computer programs recorded on one or more computer storage devices, each configured to perform the actions of the method. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

The above and other preferred features, including various novel details of implementation and combination of events, will now be more particularly described with reference to the accompanying figures and pointed out in the claims. It will be understood that the particular methods and systems described herein are shown by way of illustration only and not as limitations. As will be understood by those skilled in the art, the principles and features described herein may be employed in various and numerous embodiments without departing from the scope of the present disclosure. As can be appreciated from foregoing and following description, each and every feature described herein, and each and every combination of two or more such features, is included within the scope of the present disclosure provided that the features included in such a combination are not mutually inconsistent. In addition, any feature or combination of features may be specifically excluded from any embodiment of the present disclosure.

The foregoing Summary, including the description of some embodiments, motivations therefore, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the generally description given above and the detailed description of the preferred embodiments given below serve to explain and teach the principles described herein.

FIG. 1 (“FIG. 1”) shows an illustrative distributed computing system, according to some embodiments.

FIG. 2A shows an example of execution of a read transaction at the computing system, according to some embodiments.

FIG. 2B shows an example of execution of a write transaction at the computing system, according to some embodiments.

FIG. 3 shows an exemplary flowchart of a method for controlling execution of conflicting transactional operations, according to some embodiments.

FIG. 4 is a block diagram of an example computer system.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

Methods and systems for controlling execution of conflicting transactional operations are disclosed. It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details.

### Motivation for Some Embodiments

As described herein, isolation conflicts and consistency conflicts between transactions can cause aborts and retries for a current operation (e.g., request) of one of the transactions based on an isolation level of the database on which the transactions operate. Such aborts and retries can be problematic based on wasting work performed by a database and a connected application, increasing transaction latency, and reducing system throughput. Conventional solutions to isolation conflicts and consistency conflicts are simple. When establishing a new read snapshot (e.g., reading data of a database at an instant in time), a transaction queries for a timestamp of the latest committed transaction in the database (e.g., according to a local clock or a global clock) and uses the queried timestamp as the read snapshot timestamp. In the presence of isolation conflicts and/or consistency conflicts, the current operation of the transaction is aborted, retried, and a new read snapshot is selected using the same process.

Accordingly, improved techniques for executing transactions at a database are introduced that can avoid the deficiencies (e.g., aborts and retries of statement(s) of the transactions) that encounter conflicts (e.g., isolation conflicts and/or consistency conflicts). The improved techniques (referred to herein as “data-dependent read snapshots”) enable read snapshots of variable scope to be dynamically selected and adjusted during (e.g., at least partially through) an operation (e.g., statement of a transaction or an entire transaction) to often avoid needing to restart the entire operation due to observing a conflict. By avoiding aborts and retries, data-dependent read snapshots can enable a database to avoid wasted work, reduce transaction latency, and reduce a perceived error rate experienced by an application that interacts with the database relative to conventional solutions.

Further, a data-dependent read snapshot allows a transaction having a read snapshot to retain enough information to determine whether the transaction may dynamically adjust a read timestamp of the read snapshot (e.g., after selection of the read snapshot). In doing so, a request of the transaction can perform one or more operations based on encountering an isolation conflict or a consistency conflict. The one or more operations may include attempting to adjust the read snapshot in a manner that safely avoids the conflict, while also not invalidating any of the read operations previously executed (e.g., served) by the transaction from the read timestamp of the current read snapshot.

### Terms

“Cluster” generally refers to a deployment of computing devices that comprise a database. A cluster may include computing devices (e.g., computing nodes) that are located in one or more geographic locations (e.g., data centers). The one or more geographic locations may be located within a single geographic region (e.g., eastern United States, central United States, etc.) or more than one geographic location. For example, a cluster may include computing devices that are located in both the eastern United States and western United States, with 2 data centers in the eastern United States and 4 data centers in the western United States.

“Node” generally refers to an individual computing device (e.g., server) that is a part of a cluster. A node may join with one or more other nodes to form a cluster. One or more nodes that comprise a cluster may store data (e.g., tables, indexes, etc.) in a map of KV pairs. A node may store a “range”, which can be a subset of the KV pairs (or all of the KV pairs depending on the size of the range) stored by the cluster. A range may also be referred to as a “shard”, “tablet”, and/or “partition”. A table and its secondary indexes can be mapped to one or more ranges, where each KV pair in a range may represent a single row in the table (which can also be referred to as the primary index based on the table being sorted by the primary key) or a single row in a secondary index. Based on the range reaching or exceeding a threshold storage size, the range may split into two ranges. For example, based on reaching 512 mebibytes (MiB) in size, the range may split into two ranges. Successive ranges may split into one or more ranges based on reaching or exceeding a threshold storage size.

“Index” generally refers to a copy of the rows corresponding to a single table, where the rows are sorted by one or more columns (e.g., a column or a set of columns) of the table. Each index may correspond and/or otherwise belong to a single table. In some cases, an index may include a type. An example of a first type of index may be a primary index. A primary index may be an index on row-identifying primary key columns. A primary key constraint may be applied to one or more columns of a table to uniquely identify each row of the table, such that the primary key adds structure to table data. For a column configured with a primary key constraint, values stored in the column(s) must uniquely identify each row. One or more columns of a table may be configured with a primary key constraint and the database that includes the table may automatically create an index (referred to as a primary index) for the primary key column(s). A primary key may be defined for each table stored by a database as described herein. An example of a second type of index may be a secondary index. A secondary index may be defined on non-primary key columns of a table. A table that does not include a defined primary index may include a hidden row identifier (ID) (e.g., referred to as rowid) column that uniquely identifies each row of the table as an implicit primary index.

“Replica” generally refers to a copy of a range. A range may be replicated at least a threshold number of times to produce a number of replicas. For example and by default, a range may be replicated 3 times as 3 distinct replicas. Each replica of a range may be stored on a distinct node of a cluster. For example, 3 replicas of a range may each be stored on a different node of a cluster. In some cases, a range may be required to be replicated a minimum of 3 times to produce at least 3 replicas. In some cases, ranges may be replicated based on data survivability preferences as described further in U.S. patent application Ser. No. 17/978,752 and U.S. patent application Ser. No. 18/365,888, which are hereby incorporated by reference herein in their entireties.

“Leaseholder” or “leaseholder replica” generally refers to a replica of a range that is configured to hold the lease for the replicas of the range. The leaseholder may receive and/or coordinate read transactions and write transactions directed to one or more KV pairs stored by the range. “Leaseholder node” may generally refer to the node of the cluster that stores the leaseholder replica. The leaseholder may receive read requests of read transactions and may serve the read requests to transaction coordinators operating on gateway nodes that received the read transactions by providing read KVs to the transaction coordinators, such that the transaction coordinators can send the read KVs to client devices from which the read transactions originate. Other replicas of the range that are not the leaseholder may receive read requests and may send (e.g., route) the read requests to the leaseholder, such that the leaseholder can serve the read requests based on the read transaction.

“Raft group” or “consensus group” generally refers to a group of the replicas for a particular range. The consensus group may only include voting replicas for the range and the consensus group may participate in a distributed consensus protocol and include operations as described herein.

“Raft leader” or “leader” generally refers to a replica of the range that is a leader for managing write transactions for a range. In some cases, the leader and the leaseholder are the same replica for a range (e.g., leader is inclusive of leaseholder and/or leaseholder is inclusive of leader). In other cases, the leader and the leaseholder are not the same replica for a range. “Raft leader node” or “leader node” generally refers to a node of the cluster that stores the leader. The leader may determine that a threshold number of the replicas of a range agree to commit a write transaction prior to committing the write transaction. In some cases, the threshold number of the replicas of the range may be a majority of the replicas of the range.

“Follower” generally refers to a replica of the range that is not the leader. “Follower node” may generally refer to a node of the cluster that stores the follower replica. Follower replicas may receive write requests corresponding to transactions from the leader replica. The leader replica and the follower replicas of a range may constitute voting replicas that participate in a distributed consensus protocol and included operations (also referred to as “Raft protocol” and “Raft operations”) as described herein.

“Raft log” and “write log” generally refers to a time-ordered log of log entries indicative of write requests (e.g., included in transactions) to a range, where the log of log entries indicate write requests and the included updates to a state of the range agreed to by at least a threshold number of the replicas of the range. Each replica of a range may include a Raft log stored on the node that stores the replica. A Raft log for a replica may be stored on persistent storage (e.g., non-volatile storage such as disk storage, solid state drive (SSD) storage, etc.). A Raft log may be a source of truth for replication among nodes for a range. Each log entry included in the Raft log may be ordered based on a timestamp at which the log entry was added to the Raft log, such that application order of the updates to each replica is the same for each replica of the range.

“Consistency” generally refers to causality and the ordering of transactions within a distributed system. Consistency defines rules for operations within the distributed system, such that data stored by the system will remain consistent with respect to read and write requests originating from different sources.

“Consensus” generally refers to a threshold number of replicas for a range, based on receiving a write transaction, acknowledging a write transaction. In some cases, the threshold number of replicas may be a majority of replicas for a range. Consensus may be achieved even if one or more nodes storing replicas of a range are offline, such that the threshold number of replicas for the range can acknowledge the write transaction. Based on achieving consensus, data modified by the write transaction may be stored within the range(s) targeted by the write transaction.

“Replication” generally refers to creating and distributing copies (e.g., replicas) of the data stored by the cluster. In some cases, replication can ensure that replicas of a range remain consistent among the nodes that each comprise a replica of the range. In some cases, replication may be synchronous such that write transactions are acknowledged and/or otherwise propagated to a threshold number of replicas of a range before being considered committed to the range.

### Database Overview

A database stored by a cluster of nodes may operate based on one or more remote procedure calls (RPCs). The database may be comprised of a KV store distributed among the nodes of the cluster. In some cases, the RPCs may be SQL RPCs. In other cases, RPCs based on other programming languages may be used. Nodes of the cluster may receive SQL RPCs from client devices. After receiving SQL RPCs, nodes may convert the SQL RPCs into operations (e.g., requests) that may operate on the distributed KV store.

In some embodiments, as described herein, the KV store of the database may be comprised of one or more ranges. A range may be a selected storage size. For example, a range may be 512 MiB. Each range may be replicated to more than one node to maintain data survivability. For example, each range may be replicated to at least 3 nodes. By replicating each range to more than one node, if a node fails, replica(s) of the range would still exist on and be available on other nodes such that the range can still be accessed by client devices and replicated to other nodes of the cluster.

In some embodiments, operations directed to KV data as described herein may be executed by one or more transactions. In some cases, a node may receive a read transaction including at least one read request from a client device. A node may receive a write transaction including at least one write request from a client device. In some cases, a node can receive a read transaction or a write transaction from another node of the cluster. For example, a leaseholder node may receive a read transaction from a node that originally received the read transaction from a client device. In some cases, a node can send a read transaction to another node of the cluster. For example, a node that received a read transaction, but cannot serve the read transaction may send the read transaction to the leaseholder node. In some cases, if a node receives a read transaction or write transaction that it cannot directly serve, the node may send and/or otherwise route the transaction to the node that can serve the transaction.

In some embodiments, modifications to the data of a range may rely on a consensus protocol (e.g., a Raft protocol) to ensure a threshold number of replicas of the range agree to commit the change. The threshold may be a majority of the replicas of the range. The consensus protocol may enable consistent reads of data stored by a range.

In some embodiments, data may be written to and/or read from a storage device of a node using a storage engine that tracks the timestamp associated with the data. By tracking the timestamp associated with the data, client devices may query for historical data from a specific period of time (e.g., at a specific timestamp). A timestamp associated with a key corresponding to KV data may be assigned by a gateway node that received the transaction that wrote and/or otherwise modified the key. For a transaction that wrote and/or modified the respective key, the gateway node (e.g., the node that initially receives a transaction) may determine and assign a timestamp to the transaction based on time of a clock of the node (e.g., at the timestamp indicated by the clock when the transaction was received by the gateway node). The transaction may assign the timestamp to the KVs that are subject to (e.g., modified by) the transaction. Timestamps may enable tracking of versions of KVs (e.g., through MVCC as to be described herein) and may provide guaranteed transactional isolation. In some cases, additional or alternative methods may be used to assign versions and/or timestamps to keys and respective values.

In some embodiments, a “table descriptor” may correspond to each table of the database, where the table descriptor may contain the schema of the table and may include information associated with the table. Each table descriptor may be stored in a “descriptor table”, where each version of a table descriptor may be accessed by nodes of a cluster. In some cases, a “descriptor” may correspond to any suitable schema or subset of a schema, where the descriptor may contain the schema or the subset of the schema and may include information associated with the schema (e.g., a state of the schema). Examples of a descriptor may include a table descriptor, type descriptor, database descriptor, and schema descriptor. A view and/or a sequence as described herein may correspond to a table descriptor. Each descriptor may be stored by nodes of a cluster in a normalized or a denormalized form. Each descriptor may be stored in a KV store by nodes of a cluster. In some embodiments, the contents of a descriptor may be encoded as rows in a database (e.g., SQL database) stored by nodes of a cluster. Descriptions for a table descriptor corresponding to a table may be adapted for any suitable descriptor corresponding to any suitable schema (e.g., user-defined schema) or schema element as described herein. In some cases, a database descriptor of a database may include indications of a primary region and one or more other database regions configured for the database.

In some embodiments, database architecture for the cluster of nodes may be comprised of one or more layers. The one or more layers may process received SQL RPCs into actionable processes to access, modify, store, and return data to client devices, while providing for data replication and consistency among nodes of a cluster. The layers may comprise one or more of: a SQL layer, a transactional layer, a distribution layer, a replication layer, and a storage layer.

In some cases, the SQL layer of the database architecture exposes a SQL application programming interface (API) to developers and converts high-level SQL statements into low-level read and write requests to the underlying KV store, which are passed to the transaction layer. The transaction layer of the database architecture can implement support for atomic, consistent, isolated, and durable (ACID) transactions by coordinating concurrent operations. The distribution layer of the database architecture can provide a unified view of a cluster's data. The replication layer of the database architecture can copy data between nodes and ensure consistency between these copies by implementing a consensus protocol (e.g., consensus algorithm). The storage layer may commit writes from the Raft log to disk (e.g., a non-volatile computer-readable storage medium on a node), as well as return requested data (e.g., read data) to the replication layer.

### Transaction Layer

In some embodiments, the database architecture for a database stored by a cluster (e.g., cluster 102) of nodes may include a transaction layer. The transaction layer may enable ACID semantics for transactions within the database. The transaction layer may receive binary KV operations from the SQL layer and control KV operations sent to a distribution layer. In some cases, a storage layer of the database may use MVCC to maintain multiple versions of keys and values mapped to the keys stored in ranges of the cluster. For example, each key stored in a range may have a stored MVCC history including respective versions of the key, values for the versions of the key, and/or timestamps at which the respective versions were written and/or committed. Each version of a key may have a different timestamp, such that no versions of the key can have the same timestamp.

In some embodiments, for write transactions, the transaction layer may generate one or more locks. A lock may represent a provisional, uncommitted state for a particular value of a KV pair. The lock may be written as part of a write request of the write transaction. The database architecture described herein may include multiple lock types. In some cases, the transactional layer may generate unreplicated locks, which may be stored in an in-memory lock table (e.g., stored by volatile, non-persistent storage of a node) that is specific to the node storing the replica on which the write transaction executes. An unreplicated lock may not be replicated other replicas based on a consensus protocol as described herein. In other cases, the transactional layer may generate one or more replicated locks (referred to as “intents” or “write intents”). An intent may be a persistent, provisional value written by a transaction before the transaction commits that is stored in persistent storage (e.g., non-volatile storage such as disk storage, SSD storage, etc.) of nodes of the cluster. Each KV write performed by a transaction can initially be an intent, which includes a provisional version and a reference to the transaction's corresponding transaction record. An intent may differ from a committed value by including a pointer to a transaction record of a transaction that wrote the intent. In some cases, the intent functions as an exclusive lock on the KV data of the replica stored on the node on which the write request of the write transaction executes, thereby preventing conflicting read and write requests having timestamps greater than or equal to a timestamp corresponding to the intent (e.g., the timestamp assigned to the transaction when the intent was written). An intent may be replicated to other nodes of the cluster storing a replica of the range based on the consensus protocol as described herein. An intent for a particular key may be included in an MVCC history corresponding to the key, such that a reader of the key can distinguish the intent from other versions of committed MVCC values stored in persistent storage for the key.

In some embodiments, each transaction directed to the cluster may have a unique replicated KV pair (referred to as a “transaction record”) stored on a range stored by the cluster. The transaction for a record may be added and stored in a replica of a range on which a first write request of the write transaction occurs. The transaction record for a particular transaction may store metadata corresponding to the transaction. The metadata may include an indication of a status of a transaction and a unique identifier (ID) corresponding to the transaction. The status of a transaction may be one of: “pending” (also referred to as “PENDING”), staging (also referred to as “STAGING”), “committed” (also referred to as “COMMITTED”), or “aborted” (also referred to as “ABORTED”) as described herein. A pending state may indicate that the transaction is in progress. A staging state may be used to enable a parallel commit protocol. A committed state may indicate that the transaction has committed and the write intents written by the transaction have been recorded by follower replicas. An aborted state may indicate the write transaction has been aborted and the values (e.g., values written to the range) associated with the write transaction may be discarded and/or otherwise dropped from the range. As write intents are generated by the transaction layer as a part of a write transaction, the transaction layer may check for newer (e.g., more recent) committed values at the KVs of the range on which the write transaction is operating. If newer committed values exist at the KVs of the range, the write transaction may be restarted. Alternatively, if the write transaction identifies write intents at the KVs of the range, the write transaction may proceed as a transaction conflict as to be described herein. The transaction record may be addressable using the transaction's unique ID, such that requests can query and read a transaction's record using the transaction's ID.

In some embodiments, for read transactions, the transaction layer may execute a read transaction for KVs of a range indicated by the read transaction. The transaction layer may execute the read transaction if the read transaction is not aborted. The read transaction may read MVCC values at the KVs of the range. Alternatively, the read transaction may read intents written at the KVs, such that the read transaction may proceed as a transaction conflict as to be described herein.

In some embodiments, to commit a write transaction, the transaction layer may determine the transaction record of the write transaction as it executes. The transaction layer may restart the write transaction based on determining the state of the write transaction indicated by the transaction record is aborted. Alternatively, the transaction layer may determine the transaction record to indicate the state as pending or staging. Based on the transaction record indicating the write transaction is in a pending state, the transaction layer may set the transaction record to staging and determine whether the write intents of the write transaction have succeeded (e.g., succeeded by replication to the other nodes storing replicas of the range). If the write intents have succeeded, the transaction layer may report the commit of the transaction to the transaction coordinator operating at the gateway node. The gateway node may send an indication of a successful commit of the write transaction to the client device that initiated the write transaction.

In some embodiments, based on committing a write transaction, the transaction layer may cleanup the committed write transaction. A coordinating node to which the write transaction was directed may cleanup the committed write transaction via the transaction layer. A coordinating node may be a node that stores a replica of a range that is the subject of the transaction. In some cases, a coordinating node may be the gateway node for the transaction. The coordinating node may track a record of the KVs that were the subject of the write transaction. To clean up the transaction, the coordinating node may modify the state of the transaction record for the write transaction from staging to committed. In some cases, the coordinating node may resolve the write intents of the write transaction to MVCC (e.g., committed) values by removing the pointer to the transaction record. Based on removing the pointer to the transaction record for the write transaction, the coordinating node may delete the write intents of the transaction. Based on the deletion of each of the write intents for the transaction, the transaction record may be deleted. Additional features for a commit protocol are described at least in U.S. patent application Ser. No. 18/316,851, which is hereby incorporated by reference herein in its entirety.

In some embodiments, the transaction layer may track timing of transactions (e.g., to maintain serializability). The transaction layer may implement HLCs to track time within the cluster. An HLC may be composed of a physical component (e.g., which may be close to local actual time) and a logical component (e.g., which is used to distinguish between events with the same physical component). HLC time may always be greater than or be equal to the actual time. Each node may include a local HLC, such that the cluster operates based on locally distributed clocks operating at individual nodes.

For a transaction having a per-transaction read snapshot scope, the gateway node (e.g., the node that initially receives a transaction) may determine a timestamp for the transaction and constituent requests (e.g., requests derived from a transaction) based on an HLC time for the node. For example, the gateway node may determine a timestamp for the transaction to be equal to an HLC time of the gateway node at which the gateway node received the transaction. For a transaction having a per-statement read snapshot scope, the gateway node (e.g., the node that initially receives a transaction) may determine a timestamp for each received statement of the transaction and constituent requests of each statement based on an HLC time for the node. For example, the gateway node may determine a timestamp for a statement of the transaction to be equal to an HLC time of the gateway node at which the gateway received the statement of the transaction. The transaction layer may enable transaction timestamps based on HLC time. A timestamp within the cluster may be used to track versions of KVs (e.g., through MVCC as to be described herein) and provide guaranteed transactional isolation. A timestamp for a write intent as described herein may be equal to the assigned timestamp of a transaction corresponding to the write intent when the write intent was written to storage. A timestamp for a write intent corresponding to a transaction may be less than or equal to a commit timestamp for a transaction. When a timestamp for a write intent is less than a commit timestamp for the transaction that wrote the write intent (e.g., based on advancing the commit timestamp due to a transaction conflict or a most-recent timestamp indicated by a timestamp data structure), during asynchronous intent resolution, the committed, MVCC version of the write intent may have its respective timestamp advanced to be equal to the commit timestamp of the transaction.

For a transaction, for a node sending a request for the transaction to another node, the node may include the timestamp for the request that was generated by the local HLC (e.g., the HLC of the node) with the sent request. Based on receiving a request from another node (e.g., sender node), a node (e.g., receiver node) may inform the local HLC of the timestamp supplied with the transaction by the sender node. In some cases, the receiver node may update the local HLC of the receiver node with the timestamp included in the received transaction. Such a process may ensure that all data read and/or written to a node has a timestamp less than the HLC time at the node. Accordingly, the leaseholder for a range may serve read requests for data stored by the leaseholder, where the read requests of the read transaction that reads the data include an HLC timestamp greater than or equal to the HLC timestamp of the MVCC value read by the read transaction (e.g., such that the read occurs after the write).

To provide isolation within the cluster, based on a transaction reading a value of a range via a read request, the transaction layer may store the transaction request's timestamp in a timestamp data structure (e.g., timestamp cache) stored at the leaseholder replica of the range. For each read request directed to a range, the timestamp cache may record and include an indication of the latest timestamp (e.g., the timestamp that is the furthest ahead in time) at which value(s) of the range that were read by a read request of a transaction. Based on execution of a write transaction, the transaction layer may compare the timestamp of the write transaction to the latest timestamp indicated by the timestamp cache. If the timestamp of the write transaction is less than the latest timestamp indicated by the timestamp cache, the transaction layer may attempt to advance the timestamp of the write transaction forward to a new, later timestamp that is greater than the latest timestamp indicated by the timestamp cache. In some cases, advancing the timestamp may cause the write transaction to restart in the second phase of the transaction as to be described herein with respect to read refreshing.

As described herein, the SQL layer may convert SQL statements (e.g., received from client devices) to KV operations. KV operations generated from the SQL layer may use a Client Transaction (CT) transactional interface of the transaction layer to interact with the KVs stored by the cluster. The CT transactional interface may include a transaction coordinator. The transaction coordinator may perform one or more operations as a part of the transaction layer. Based on the execution of a transaction, the transaction coordinator may send (e.g., periodically send) “heartbeat” messages to a transaction record for the transaction. These messages may indicate that the transaction should keep executing (e.g., be kept alive). If the transaction coordinator fails to send the “heartbeat” messages, the transaction layer may modify the transaction record for the transaction to an aborted status. The transaction coordinator may track each written KV and/or KV range during execution of a transaction. In some embodiments, the transaction coordinator may clean and/or otherwise clear accumulated transaction operations. The transaction coordinator may clear an accumulated write intent for a write transaction based on the status of the transaction changing to committed or aborted.

As described herein, to track the status of a transaction during execution, the transaction layer can write to a transaction record corresponding to the transaction. Write intents of the transaction may route conflicting transactions to the transaction record based on the pointer to the transaction record included in the write intents, such that the conflicting transaction may determine a status for conflicting write intents as indicated in the transaction record. The transaction layer may write a transaction record to the same range as the first key subject to a transaction. The transaction coordinator may track the first key subject to a transaction. In some cases, the transaction layer may generate the transaction record when one of the following occurs: the write request commits; the transaction coordinator sends heartbeat messages for the transaction; or a request forces the transaction to abort. As described herein, a transaction record may have one of the following states: pending, committed, staging, or aborted. In some cases, the transaction record may not exist. If a transaction encounters a write intent where a transaction record corresponding to the write intent does not exist, the transaction may use the timestamp of the write intent to determine how to proceed with respect to the observed write intent. If the timestamp of the write intent is within a transaction liveness threshold, the write intent may be treated as pending. If the timestamp of the write intent is not within the transaction liveness threshold, the write intent may be treated as aborted. A transaction liveness threshold may be a duration configured based on a time period for sending “heartbeat” messages. For example, the transaction liveness threshold may be a duration lasting for five “heartbeat” message time periods, such that after five missed heartbeat messages, a transaction may be aborted. The transaction record for a committed transaction may remain until each of the write intents of the transaction are converted to committed MVCC values stored on persistent storage of a node.

As described herein, in the transaction layer, values may not be written directly to the storage layer as committed MVCC values during a write transaction. Values may be written in a provisional (e.g., uncommitted) state referred to as a write intent. Write intents may be MVCC values including a pointer to a transaction record to which the MVCC value belongs. Based on interacting with a write intent (instead of a committed MVCC value), a request may determine the status of the transaction record, such that the request may determine how to interpret the write intent. As described herein, if a transaction record is not found for a write intent, the request may determine the timestamp of the write intent to evaluate whether or not the write intent may be considered to be expired.

In some embodiments, the transaction layer may include a concurrency manager for concurrency control. The concurrency manager may sequence incoming requests (e.g., from transactions) and may provide isolation between the transactions that issued those requests that intend to perform conflicting operations. This activity may be referred to as concurrency control. The concurrency manager may combine the operations of a latch manager and a lock table to accomplish this work. The latch manager may sequence the incoming requests and may provide isolation between those requests. The lock table may provide locking and sequencing of requests (in combination with the latch manager). The lock table may be a per-node, in-memory (e.g., stored by volatile, non-persistent storage) data structure. The lock table may hold a collection of locks acquired by transactions that are in-progress as to be described herein.

As described herein, the concurrency manager may be a structure that sequences incoming requests and provides isolation between the transactions that issued those requests, where the requests intend to perform conflicting operations. During sequencing, the concurrency manager may identify conflicts. The concurrency manager may resolve conflicts based on passive queuing and/or active pushing. Once a request has been sequenced by the concurrency manager, the request may execute (e.g., without other conflicting requests) based on the isolation provided by the concurrency manager. This isolation may last for the duration of the request. The isolation may terminate based on (e.g., after) completion of the request. Each request in a transaction may be isolated from other requests. Each request may be isolated during the duration of the request, after the request has completed (e.g., based on the request acquiring locks), and/or within the duration of the transaction comprising the request. The concurrency manager may allow transactional requests (e.g., requests originating from statements of transactions) to acquire locks, where the locks may exist for durations longer than the duration of the requests themselves. The locks may extend the duration of the isolation provided over specific keys of ranges stored by the cluster to the duration of the transaction. The locks may be released when the transaction commits or aborts. Other requests that encounter and/or otherwise interact with the locks (e.g., while being sequenced) may wait in a queue for the locks to be released. Based on the locks being released, the other requests may proceed to execute. The concurrency manager may include information for external locks (e.g., the write intents).

In some embodiments, one or more locks may not be controlled by the concurrency manager, such that one or more locks may not be discovered during sequencing. As an example, write intents (e.g., replicated, exclusive locks) may be stored such that that may not be detected until request evaluation time. In most embodiments, fairness may be ensured between requests, such that if any two requests conflict, the request that arrived first will be sequenced first. Sequencing may guarantee first-in, first-out (FIFO) semantics. An exception to FIFO semantics is that a request that is part of a transaction which has already acquired a lock may not need to wait on that lock during sequencing. The request may disregard any queue that has formed on the lock. Lock tables as to be described herein may include one or more other exceptions to the FIFO semantics described herein.

In some embodiments, as described herein, a lock table may be a per-node, in-memory data structure. The lock table may store a collection of locks acquired by in-progress transactions. Each lock in the lock table may have an associated lock wait-queue. Conflicting transactions can queue in the associated lock wait-queue based on waiting for the lock to be released. Items in the locally stored lock wait-queue may be propagated as necessary (e.g., via RPC) to an existing Transaction Wait Queue (TWQ). The TWQ may be stored on the leader replica of the range, where the leader replica on which the first write request of a transaction occurred may contain the transaction record.

As described herein, databases stored by the cluster may be read and written using one or more “requests”. A transaction may be composed of one or more statements (e.g., SQL statements), where each statement includes one or more requests, such as read requests and write requests. A read request may be a request to read data stored by a range, such as a value of a particular key at a timestamp corresponding to the request. A write request may be a request to write (e.g., update or modify) data stored by a range, such that the write request writes a value for a key included in the range. For example, a write request may write a value for a new version of a key. Isolation may be needed to separate requests. Additionally, isolation may be needed to separate transactions. Isolation for requests and/or transactions may be accomplished by maintaining multiple versions and/or by allowing requests to acquire locks. Isolation based on multiple versions may require a form of mutual exclusion, such that a read and a conflicting lock acquisition do not occur concurrently. The lock table may provide locking and/or sequencing of requests (in combination with the use of latches).

In some embodiments, locks may last for a longer duration than the requests associated with the locks. Locks may extend the duration of the isolation provided over specific KVs to the duration of the transaction associated with the lock. As described herein, locks may be released when the transaction commits or aborts. Other requests that encounter and/or otherwise interact with the locks (e.g., while being sequenced) may wait in a queue for the locks to be released. Based on the locks being released, the other requests may proceed. In some embodiments, the lock table may enable fairness between requests, such that if two requests conflict, then the request that arrived first may be sequenced first. In some cases, there may be exceptions to the FIFO semantics as described herein. A request that is part of a transaction that has acquired a lock may not need to wait on that lock during sequencing, such that the request may ignore a queue that has formed on the lock. In some embodiments, contending requests that encounter different levels of contention may be sequenced in a non-FIFO order. Such sequencing in a non-FIFO order may enable greater concurrency. As an example, if requests R₁ and R₂ contend on key K₂, but R₁ is also waiting at key K₁, R₂ may be determined to have priority over R₁, such that R₂ may be executed on K₂.

In some embodiments, as described herein, a latch manager may sequence incoming requests and may provide isolation between those requests. The latch manager may sequence and provide isolation to requests under the supervision of the concurrency manager. A latch manager may operate as follows. As write requests occur for a range, a leaseholder of the range may serialize write requests for the range. Serializing the requests may group the requests into a consistent order. To enforce the serialization, the leaseholder may create a “latch” for the keys in the write value, such that a write request may be given uncontested access to the keys. If other requests access the leaseholder for the same set of keys as the previous write request, the other requests may wait for the latch to be released before proceeding. In some cases, read requests may generate latches. Multiple read latches over the same keys may be held concurrently. A read latch and a write latch over the same keys may not be held concurrently.

In some embodiments, the transaction layer may execute transactions at a serializable transaction isolation level. A serializable isolation level may not prevent anomalies in data stored by the cluster. A serializable isolation level may be enforced by requiring the client device to retry transactions if serializability violations are possible. In some embodiments, the transaction layer may execute transactions at an isolation level different from a serializable isolation level. In some cases, the transaction layer may execute transactions at other isolation levels, such as a read committed isolation level and a snapshot isolation level.

In some embodiments, the transaction layer may allow for one or more transaction conflict types, where a conflict type may result from a transaction encountering and/or otherwise interacting with a write intent at a key (e.g., at least one key). A write/write conflict may occur when two concurrent transactions attempt to write to (e.g., create write intents for) the same key. A write/read conflict may occur when a read request of a transaction encounters an existing write intent with a timestamp less than or equal to the timestamp of the read request. To resolve the transaction conflict, the transaction layer may proceed through one or more operations. Based on a transaction within the transaction conflict having a defined transaction priority (e.g., high priority, low priority, etc.), the transaction layer may abort the transaction with lower priority (e.g., in a write/write conflict) or advance the timestamp of the transaction having a lower priority (e.g., in a write/read conflict). Based on a transaction within the conflicting transactions being expired, the expired transaction may be aborted. A transaction may be considered to be expired if the transaction does not have a transaction record or the timestamp for the transaction is outside of the transaction liveness threshold. A transaction may be considered to be expired if the transaction record corresponding to the transaction has not received a “heartbeat” message from the transaction coordinator within the transaction liveness threshold. A transaction (e.g., a low priority transaction) that is required to wait on a conflicting transaction may enter the TWQ as described herein.

In some embodiments, the transaction layer may allow for one or more additional conflict types that do not involve write intents. A read/write conflict (also referred to herein as a “write after read conflict”) may occur when a write transaction having a lower timestamp conflicts with a read transaction having an equal or higher timestamp. The timestamp of the write transaction may be advanced to be greater than the timestamp of the read transaction, such that the write transaction may execute. A read within an uncertainty interval (also referred to as an “uncertainty window”) may occur when a read transaction encounters a KV having a higher timestamp than the timestamp of the read transaction and there exists ambiguity whether the KV should be considered to be committed in the future or in the past of the read transaction. An uncertainty interval may be configured based on the maximum allowed offset (e.g., maximum allowed difference in time) between the clocks (e.g., HLCs) of any two nodes within the cluster. In an example, a duration of the uncertainty interval may be equal to the maximum allowed offset, where the uncertainty interval is defined as (t, t+d], where t refers to the initial timestamp of the read transaction and d refers to the duration of the uncertainty interval. A read within an uncertainty interval may occur based on clock skew between clocks operating on different nodes. In some cases, the transaction layer may advance the timestamp of the read transaction to be greater than the timestamp of the KV according to read refreshing as described herein. If the read transaction associated with a read within an uncertainty interval has to be aborted and retried, the read transaction may never encounter an uncertainty interval on any node which was previously visited by the read transaction. In some cases, there may not exist an uncertainty interval for KVs read from the gateway node of the read transaction. An amount of work to be aborted and retried may depend on a read snapshot scope and corresponding isolation level for a transaction. A first transaction that adheres to an isolation level having a per-statement read snapshot scope may only be required to abort and retry an individual statement of the first transaction while a second transaction that adheres to an isolation level having a per-transaction read snapshot scope may be required to abort and retry all statements of the transaction. When a first transaction adheres to an isolation level having a per-statement read snapshot scope, an amount of work aborted and retried by the first transaction may be relatively less work than a second transaction that adheres to an isolation level having a per-transaction read snapshot scope.

In some embodiments, as described herein, the TWQ may track all transactions that could not advance another blocking, ongoing transaction that wrote write intents observed by the tracked transactions. The transactions tracked by the TWQ may be queued and may wait for the blocking transaction to complete before the transaction can proceed to execute. The structure of the TWQ may map a blocking transaction to the one or more other transactions that are blocked by the blocking transaction via the respective unique IDs corresponding to each of the transactions. The TWQ may operate on the leader replica of a range, where the leader replica includes the transaction record based on being subject to the first write request included in the blocking, ongoing transaction. Based on a blocking transaction resolving (e.g., by committing or aborting), an indication may be sent to the TWQ that indicates the queued transactions blocked by the blocking transaction may begin to execute. A blocked transaction (e.g., a transaction blocked by a blocking transaction) may examine their transaction status to determine whether they are active. If the transaction status for the blocked transaction indicates the blocked transaction is aborted, the blocked transaction may be removed by the transaction layer. In some cases, deadlock may occur between transactions, where a first transaction may be blocked by second write intents of a second transaction and the second transaction may be blocked by first write intents of the first transaction. If transactions are deadlocked (e.g., blocked on write intents of another transaction), one of the deadlocked transactions may randomly abort, such that the remaining, active (e.g., alive) transaction may execute and the deadlock may be removed. A deadlock detection mechanism may identify whether transactions are deadlocked and may cause one of the deadlocked transactions to abort.

In some embodiments, the transaction layer may enable read refreshing. When a timestamp of a transaction has been advanced to a new, later timestamp, additional considerations may be required before the transaction may commit at the advanced timestamp. The considerations may include checking KVs previously read by the transaction to verify that other write transactions have not occurred at the KVs between the original transaction timestamp and the advanced transaction timestamp. This consideration may prevent serializability violations. The check may be executed by tracking each read using a Refresh Request (RR). If the check succeeds (e.g., write transactions have not occurred between the original transaction timestamp and the advanced transaction timestamp), the transaction may be allowed to commit at the advanced timestamp. A transaction may perform the check at a commit time if the transaction was advanced by a different transaction or by the timestamp cache. A transaction may perform the check based on encountering a read within an uncertainty interval or a write/write conflict. If the check is unsuccessful, then the transaction may be retried at the advanced timestamp.

In some embodiments, the transaction layer may enable transaction pipelining. Write transactions may be pipelined when being replicated to follower replicas and when being written to storage. Transaction pipelining may reduce the latency of transactions that perform multiple writes. In transaction pipelining, write intents may be replicated from leaseholders (e.g., combined leaseholder and leader replicas) to follower replicas in parallel, such that waiting for a commit occurs at transaction commit time. Transaction pipelining may include one or more operations. In transaction pipelining, for each received statement (e.g., including one or more requests) of a transaction, the gateway node corresponding to the transaction may communicate with the leaseholders (L₁, L₂, L₃, . . . , Lᵢ) for the range(s) indicated by the transaction. Each leaseholder Lᵢ may receive the communication from the gateway node and may perform one or more operations in parallel. Each leaseholder Lᵢ may (i) create write intents, and (ii) send the write intents to corresponding follower nodes for the leaseholder Lᵢ. After sending the write intents to the corresponding follower nodes, each leaseholder Lᵢ may send an indication to the transaction coordinator on the gateway node that the write intents have been sent. Replication of the intents may be referred to as “in-flight” once the leaseholder Lᵢ sends the write intents to the follower replicas. Before committing the transaction (e.g., by updating the transaction record for the transaction via a transaction coordinator), the gateway node may wait for the write intents to be replicated in parallel to each of the follower nodes of the leaseholders. Based on receiving responses from the leaseholders that the write intents have propagated to the follower nodes, the gateway node may commit the transaction by causing an update to the status of the transaction record of the transaction. Additional features of distributed consensus (e.g., Raft) operations are described with respect to “Transaction Execution”.

### Storage Layer

In some embodiments, the database architecture for databases stored by a cluster (e.g., cluster 102) of database nodes may include a storage layer. The storage layer may enable the cluster to read and write data to storage device(s) of each node. As described herein, data may be stored as KV pairs on the storage device(s) using a storage engine. In some cases, the storage engine may be a Pebble storage engine. The storage layer may serve successful read transactions and write transactions from the replication layer.

In some embodiments, each node of the cluster may include at least one store, which may be specified when a node is activated and/or otherwise added to a cluster. Read transactions and write transactions may be processed from the store. Each store may contain two instances of the storage engine as described herein. A first instance of the storage engine may store temporary distributed SQL data. A second instance of the storage engine may store data other than the temporary distributed SQL data, including system data (e.g., meta ranges) and user data (e.g., table data, client data, etc.). For each node, a block cache may be shared between each store of the node. The store(s) of a node may store a collection of replicas of a range as described herein, where a particular replica may not be replicated among stores of the same node (or the same node), such that a replica may only exist once at a node.

In some embodiments, as described herein, the storage layer may use an embedded KV data store (e.g., Pebble). The KV data store may be used with an application programming interface (API) to read and write data to storage devices (e.g., persistent storage devices) of nodes of the cluster. The KV data store may enable atomic write batches and snapshots.

In some embodiments, the storage layer may use MVCC to enable concurrent requests. In some cases, the use of MVCC by the storage layer may guarantee consistency for the cluster. As described herein, HLC timestamps may be used to differentiate between different versions of data (e.g., KVs) by tracking commit timestamps for the data. HLC timestamps may be used to identify a garbage collection expiration for a value as to be described herein. In some cases, the storage layer may support time travel queries (e.g., queries directed to MVCC versions of keys at previous timestamps). Time travel queries may be enabled by MVCC versions of keys.

In some embodiments, the storage layer may aggregate MVCC values (e.g., garbage collect MVCC values) to reduce the storage size of the data stored by the storage (e.g., the disk) of nodes. The storage layer may compact MVCC values (e.g., old MVCC values) based on the existence of a newer MVCC value with a timestamp that is older than a garbage collection period. A garbage collection period may be configured for the cluster, database, and/or table. Garbage collection may be executed for MVCC values that are not configured with a protected timestamp. A protected timestamp subsystem may ensure safety for operations that rely on historical data. Operations that may rely on historical data may include imports, backups, streaming data using change feeds, and/or online schema changes. Protected timestamps may operate based on generation of protection records by the storage layer. Protection records may be stored in an internal system table. In an example, a long-running job (e.g., such as a backup) may protect data at a certain timestamp from being garbage collected by generating a protection record associated with that data and timestamp. Based on successful creation of a protection record, the MVCC values for the specified data at timestamps less than or equal to the protected timestamp may not be garbage collected. When the job (e.g., the backup) that generated the protection record is complete, the job may remove the protection record from the data. Based on removal of the protection record, the garbage collector may operate on the formerly protected data.

In some embodiments, the storage layer may use a log-structured merge (LSM) tree at each node of the cluster to manage data storage. In some cases, other types of data storage structures, such as a B-tree, may be used in addition or in place of an LSM tree at each node. In some cases, the LSM tree is a hierarchical tree including a number of levels. For each level of the LSM tree, one or more files may be stored on persistent storage media (e.g., disk storage, solid state drive (SSD) storage, etc.) that include the data referenced at that respective level. The files may be sorted string table files as described herein. In some cases, sstables are an on-disk (e.g., on persistent, non-volatile storage such as disk storage, SSD storage, etc.) representation of sorted lists of KV pairs. Sstables can be immutable, such that they are never modified (e.g., even during a compaction process) and instead are deleted and written.

### Database Architecture

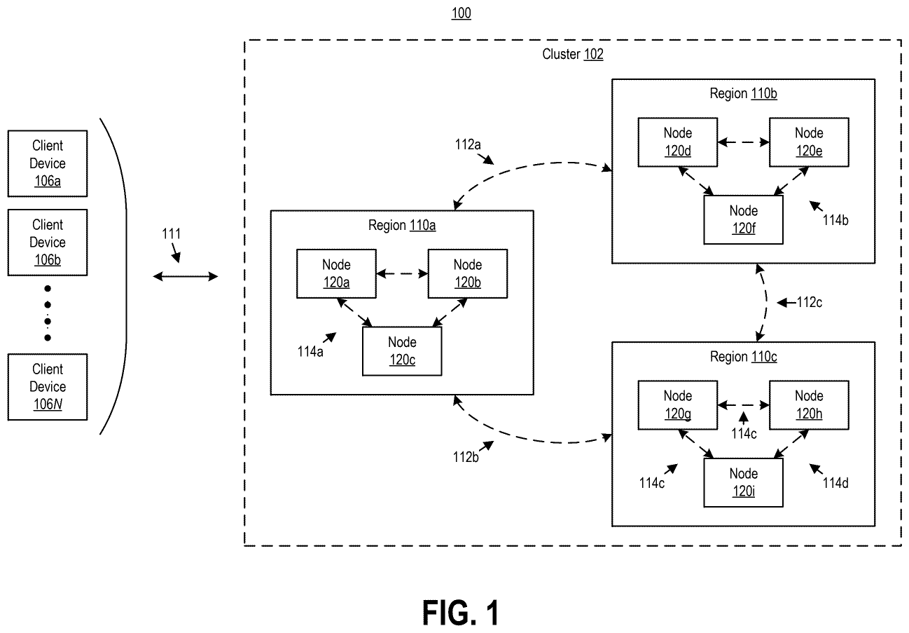

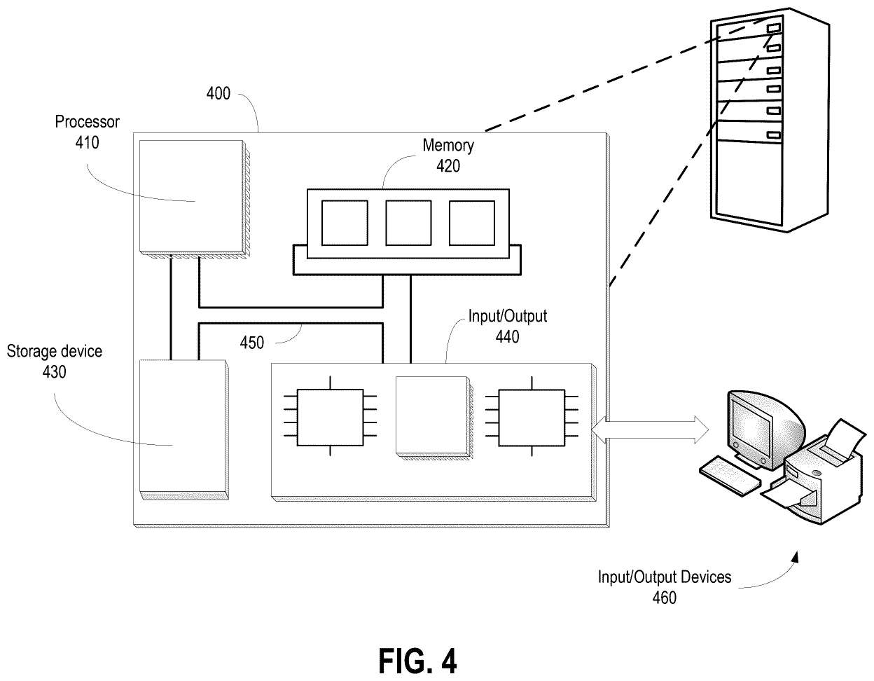

Referring to FIG. 1, an illustrative distributed computing system 100 is presented. The computing system 100 may include a cluster 102. In some cases, the computing system may include one or more additional clusters 102. The cluster 102 may include one or more nodes 120 distributed among one or more geographic regions 110. The geographic regions may correspond to cluster regions and database regions as described further below. A node 120 may be a computing device (e.g., a server computing device). In some cases, a node 120 may include at least portions of the computing system as described herein with respect to FIG. 4. As an example, a node 120 may be a server computing device. A region 110 may correspond to a particular building (e.g., a data center), city, state/province, country, geographic region, and/or a subset of any one of the above. A region 110 may include multiple elements, such as a country and a geographic identifier for the country. For example, a region 110 may be indicated by Country=United States and Region=Central, which may indicate a region 110 as the Central United States. As shown in FIG. 1, the cluster 102 may include regions 110a, 110b, and 110c. In some cases, the cluster 102 may include one region 110. In an example, the region 110a may be the Eastern United States, the region 110b may be the Central United States, and the region 110c may be the Western United States. Each region 110 of the cluster 102 may include one or more nodes 120. In some cases, a region 110 may not include any nodes 120. The region 110a may include nodes 120a, 120b, and 120c. The region 110b may include the nodes 120d, 120e, and 120f. The region 110c may include nodes 120g, 120h, and 120i.

Each node 120 of the cluster 102 may be communicatively coupled via one or more networks 112 and 114. In some cases, the cluster 102 may include networks 112a, 112b, and 112c, as well as networks 114a, 114b, 114c, and 114d. The networks 112 may include a local area network (LAN), wide area network (WAN), and/or any other suitable network. In some cases, the one or more networks 112 may connect nodes 120 of different regions 110. The nodes 120 of region 110a may be connected to the nodes 120 of region 110b via a network 112a. The nodes 120 of region 110a may be connected to the nodes 120 of region 110c via a network 112b. The nodes 120 of region 110b may be connected to the nodes 120 of region 110c via a network 112c. The networks 114 may include a LAN, WAN, and/or any other suitable network. In some cases, the networks 114 may connect nodes 120 within a region 110. The nodes 120a, 120b, and 120c of the region 110a may be interconnected via a network 114a. The nodes 120d, 120e, and 120f of the region 110b may be interconnected via a network 114b. In some cases, the nodes 120 within a region 110 may be connected via one or more different networks 114. The node 120g of the region 110c may be connected to nodes 120h and 120i via a network 114c, while nodes 120h and 120i may be connected via a network 114d. In some cases, the nodes 120 of a region 110 may be located in different geographic locations within the region 110. For example, if region 110a is the Eastern United States, nodes 120a and 120b may be located in New York, while node 120c may be located in Massachusetts.

In some embodiments, the computing system 100 may include one or more client devices 106. The one or more client devices 106 may include one or more computing devices. In some cases, the one or more client devices 106 may each include at least portions of the computing system as described herein with respect to FIG. 4. In an example, the one or more client devices 106 may include laptop computing devices, desktop computing devices, mobile computing devices, tablet computing devices, and/or server computing device. As shown in FIG. 1, the computing system 100 may include client devices 106a, 106b, and one or more client devices 106 up to client device 106N, where N is any suitable number of client devices 106 included in the computing system 100. The client devices 106 may be communicatively coupled to the cluster 102, such that the client devices 106 may access and/or otherwise communicate with the nodes 120. One or more networks 111 may couple the client devices 106 the nodes 120. The one or more networks 111 may include a LAN, a WAN, and/or any other suitable network as described herein. As an example, the client devices 106 may communicate with the nodes 120 via a SQL client (e.g., an application) operating at each respective client device 106. To access and/or otherwise interact with the data stored by the cluster 102, a client device 106 may communicate with a gateway node, which may be a node 120 of the cluster that is closest (e.g., by latency, geographic proximity, and/or any other suitable indication of closeness) to the client device 106. The gateway node may route communications between a client device 106 and any other node 120 of the cluster. In some cases, one or more applications may operate on the client devices 106, such that the application(s) may interface with the nodes 120 to access, modify, and/or retrieve stored KV data.

### Transaction Execution

In some embodiments, as described herein, distributed transactional databases stored by the cluster (e.g., cluster 102) of database nodes may enable one or more transactions. Each transaction may include one or more requests directed to performing one or more operations. The one or more requests may include read requests and/or write requests. In some cases, a request may be a query (e.g., a SQL query). A request may traverse one or more nodes of a cluster to execute the request. A request may interact with (e.g., sequentially interact with) one or more of the following: a SQL client, a load balancer, a gateway, a leaseholder, and/or a Raft leader as described herein. A SQL client may send a request (e.g., query) to a cluster. The request may be included in a transaction, where the transaction is a read and/or a write transaction as described herein. A load balancer may route the request from the SQL client to the nodes of the cluster. A gateway node may be a node that initially receives the request and/or sends a response to the SQL client. A leaseholder may be a node that serves read requests and coordinates write requests for a range of keys (e.g., keys indicated in the request) as described herein. Serving a read request may include reading, by a request, a value(s) of stored keys and sending the read values from the node on which the values were stored to the transaction coordinator for the transaction corresponding to the request, where the transaction coordinator for the transaction can operate on a gateway node that originally received the transaction (e.g., from a client device). A Raft leader may be a node that maintains consensus among the replicas for a range via coordination of a consensus protocol.

A SQL client (e.g., operating at a client device 106a) may send a request (e.g., a SQL request) to a cluster (e.g., cluster 102). The request may be sent over a network (e.g., the network 111). A load balancer may determine a node of the cluster to which to send the request. The node may be a node of the cluster having the lowest latency and/or having the closest geographic location to the computing device on which the SQL client is operating. A gateway node (e.g., node 120a) may receive the request from the load balancer. The gateway node may parse the request to determine whether the request is valid. The request may be valid based on conforming to the syntax (e.g., SQL syntax) of the database(s) stored by the cluster. An optimizer operating at the gateway node may generate a number of logically equivalent query plans based on the received request. Each query plan may correspond to a physical operation tree configured to be executed for the query. The optimizer may select an optimal query plan from the number of query plans (e.g., based on a cost model). Based on the completion of request planning, a query execution engine may execute the selected, optimal query plan using a transaction coordinator as described herein. A transaction coordinator operating on a gateway node may perform one or more operations as a part of the transaction layer. The transaction coordinator may cause execution of KV operations on a database stored by the cluster. The transaction coordinator may account for keys indicated and/or otherwise involved in a transaction. The transaction coordinator may package KV operations into a Batch Request as described herein, where the Batch Request may be forwarded on to a Distribution Sender (DistSender) operating on the gateway node.

A DistSender of a gateway node and/or coordinating node may receive Batch Requests from a transaction coordinator of the same node. The DistSender of the gateway node may receive the Batch Request from the transaction coordinator. The DistSender may determine the operations indicated by the Batch Request and may determine the node(s) (e.g., the leaseholder node(s)) that should receive requests corresponding to the operations for the range. The DistSender may generate one or more Batch Requests based on determining the operations and the node(s) as described herein. The DistSender may send a first Batch Request for each range in parallel. Based on receiving a provisional acknowledgment from a leaseholder node's evaluator, the DistSender may send the next Batch Request for the range corresponding to the provisional acknowledgement. The DistSender may wait to receive acknowledgments for write requests and values for read requests corresponding to the sent Batch Requests.

As described herein, the DistSender of the gateway node may send Batch Requests to leaseholders (or other replicas) for data indicated by the Batch Request. In some cases, the DistSender may send Batch Requests to nodes that are not the leaseholder for the range (e.g., based on out of date leaseholder information). Nodes may or may not store the replica indicated by the Batch Request. Nodes may respond to a Batch Request with one or more responses. A response may indicate the node is no longer a leaseholder for the range. The response may indicate the last known address of the leaseholder for the range. A response may indicate the node does not include a replica for the range. A response may indicate the Batch Request was successful if the node that received the Batch Request is the leaseholder. The leaseholder may process the Batch Request. As a part of processing of the Batch Request, each write request in the Batch Request may compare a timestamp of the write request to the timestamp cache. A timestamp cache may track the highest timestamp (e.g., most recent timestamp) for any read request that a given range has served. The comparison may ensure that the write request has a higher timestamp than any timestamp indicated by the timestamp cache. If a write request has a lower timestamp than any timestamp indicated by the timestamp cache, the write request may be restarted at an advanced timestamp that is greater than the value of the most recent timestamp indicated by the timestamp cache.

In some embodiments, operations indicated in the Batch Request may be serialized by a latch manager of a leaseholder. For serialization, each write request may be given a latch on a row. Any read and/or write requests that arrive after the latch has been granted on the row may be required to wait for the write request to complete. Based on completion of the write request, the latch may be released and the subsequent requests can proceed to execute. In some cases, a batch evaluator may ensure that write requests are valid. The batch evaluator may determine whether the write request is valid based on the leaseholder's data. The leaseholder's data may be evaluated by the batch evaluator based on the leaseholder coordinating write requests to the range. If the batch evaluator determines the write request to be valid, the leaseholder may send a provisional acknowledgement to the DistSender of the gateway node, such that the DistSender may begin to send subsequent Batch Requests for the range to the leaseholder.

In some embodiments, requests may read from the local instance of the storage engine as described herein to determine whether write intents are present at a key. If write intents are present at a particular key, an request may resolve write intents as described herein. If the request is a read request and write intents are not present at the key, the read request may read the value at the key of the leaseholder's storage engine. Read responses corresponding to a transaction may be aggregated into a Batch Response by the leaseholder. The Batch Response may be sent to the DistSender of the gateway node. If the request is a write request and write intents are not present at the key, the KV operations included in the Batch Request that correspond to the write request may be converted to distributed consensus (e.g., Raft) operations and write intents, such that the write request may be replicated to the replicas of the range.

With respect to a single round of distributed consensus, the leaseholder may propose the Raft operations to the leader replica of the Raft group (e.g., where the leader replica is typically also the leaseholder). Based on receiving the Raft operations, the leader replica may send the Raft operations to the follower replicas of the Raft group. Writing and/or execution of Raft operations as described herein may include writing one or more write intents to persistent storage. The leader replica and the follower replicas may attempt to write the Raft operations to their respective Raft logs. When a particular replica writes the Raft operations to its respective local Raft log, the replica may acknowledge success of the Raft operations by sending an indication of a success of writing the Raft operations to the leader replica. If a threshold number of the replicas acknowledge writing the Raft operations (e.g., the write operations) to their respective Raft log, consensus may be achieved such that the Raft operations may be committed (referred to as “consensus-committed” or “consensus-commit”). The consensus-commit may be achieved for a particular Raft operation when a majority of the replicas (e.g., including or not including the leader replica) have written the Raft operation to their local Raft log. The consensus-commit may be discovered or otherwise known to the leader replica to be committed when a majority of the replicas have sent an indication of success for the Raft operation to the leader replica. Based on a Raft operation (e.g., write operation) being consensus-committed among a Raft group, each replica included in the Raft group may apply the committed entry to their respective local state machine. Based on achieving consensus-commit among the Raft group, the Raft operations (e.g., write operations included in the write transaction) may be considered to be committed (e.g., implicitly committed as described herein). The gateway node may update the status of the transaction record for the transaction corresponding to the Raft operations to committed (e.g., explicitly committed as described herein). A latency for the above-described distributed consensus round may be equal to a duration for sending a Raft operation from the leader replica to the follower replicas, receiving success responses for the Raft operation at the leader replica from at least some of the follower replicas (e.g., such that a majority of replicas write to their respective Raft log), and writing a write intent to persistent storage at the leader and follower replicas in parallel.

In some embodiments, based on the leader replica writing the Raft operations to the Raft log and receiving an indication of the consensus-commit among the Raft group, the leader replica may send a commit acknowledgement to the DistSender of the gateway node. The DistSender of the gateway node may aggregate commit acknowledgements from each write operation included in the Batch Request. In some cases, the DistSender of the gateway node may aggregate read values for each read request included in the Batch Request. Based on completion of the operations of the Batch Request, the DistSender may record the success of each transaction in a corresponding transaction record. To record the success of a transaction, the DistSender may check the timestamp cache of the range where the first request of the write transaction occurred to determine whether the timestamp for the write transaction was advanced. If the timestamp was advanced, the transaction may perform a read refresh to determine whether values associated with the transaction had changed. If the read refresh is successful (e.g., no values associated with the transaction had changed), the transaction may commit at the advanced timestamp. If the read refresh fails (e.g., at least some value associated with the transaction had changed), the transaction may be restarted. Based on determining the read refresh was successful and/or that the timestamp was not advanced for a write transaction, the DistSender may change the status of the corresponding transaction record to committed as described herein. The DistSender may send values (e.g., read values) to the transaction coordinator. The transaction coordinator may send the values to the SQL layer. In some cases, the transaction coordinator may also send a request to the DistSender, where the request includes an indication for the DistSender to convert write intents to committed values (e.g., MVCC values). The SQL layer may send the values as described herein to the SQL client that initiated the query (e.g., operating on a client device).

### Read Transaction Execution

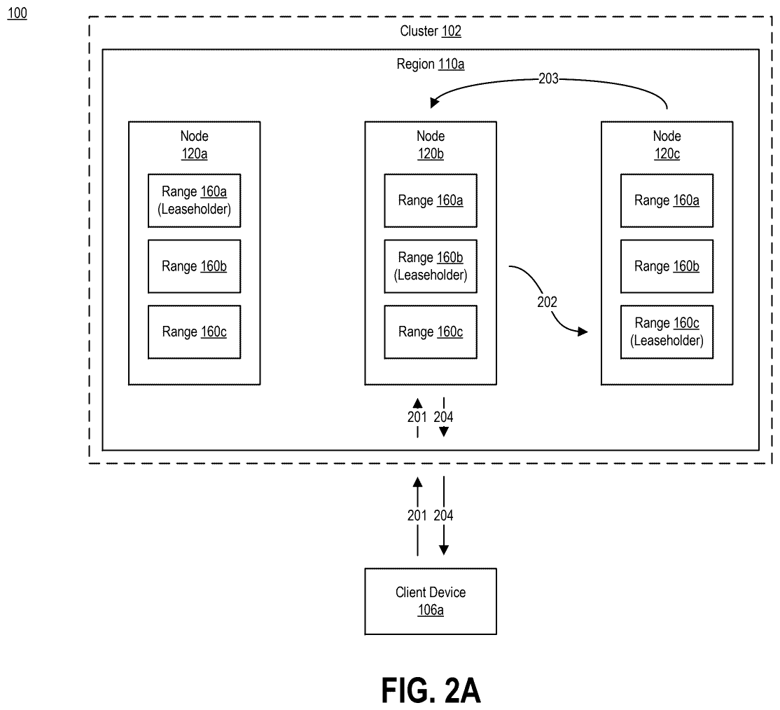

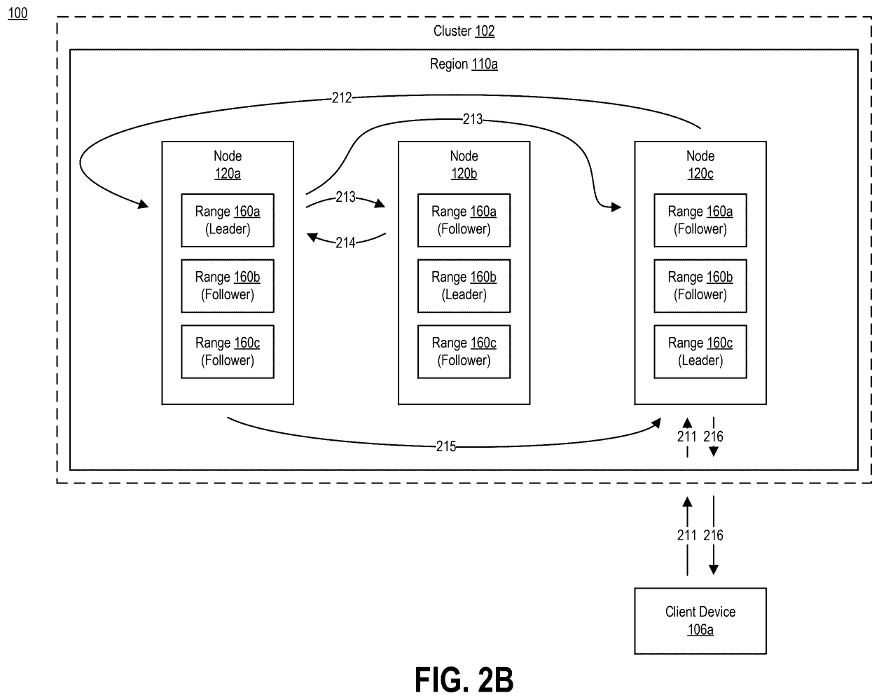

Referring to FIG. 2A, an example of execution of a read transaction including at least one read request at the computing system 100 is presented. In some cases, the nodes 120a, 120b, and 120c, of region 110a may include one or more replicas of ranges 160. The node 120a may include replicas of ranges 160a, 160b, and 160c, where ranges 160a, 160b, and 160c are different ranges. The node 120a may include the leaseholder replica for range 160a (as indicated by “Leaseholder” in FIG. 2A). The node 120b may include replicas of ranges 160a, 160b, and 160c. The node 120b may include the leaseholder replica for range 160b (as indicated by “Leaseholder” in FIG. 2A). The node 120c may include replicas of ranges 160a, 160b, and 160c. The node 120c may include the leaseholder replica for range 160c (as indicated by “Leaseholder” in FIG. 2A). While FIG. 2A is described with respect to communication between nodes 120 of a single region (e.g., region 110a), a read transaction may operate similarly between nodes 120 located within different geographic regions.

In some embodiments, a client device 106 may initiate a read transaction at a node 120 of the cluster 102. Based on the KVs indicated by the read transaction, the node 120 that initially receives the read transaction (e.g., the gateway node) from the client device 106 may route the read request(s) of the read transaction to a leaseholder of the range 160 comprising the KVs indicated by the read transaction. The leaseholder of the range 160 may serve the read requests and send the read data to the gateway node. The gateway node may send the read data to the client device 106.

As shown in FIG. 2A, at step 201, the client device 106 may send a read transaction to the cluster 102. The read transaction may be received by node 120b as the gateway node. The node 120b may be a node 120 located closest to the client device 106, where the closeness between the nodes 120 and a client device 106 may correspond to a latency and/or a proximity as described herein. The read transaction may be directed to data stored by the range 160c. At step 202, the node 120b may route read request(s) of the received read transaction to node 120c. The read transaction may be routed to node 120c based on the node 120c being the leaseholder of the range 160c. The node 120c may receive the read request(s) from node 120b and serve the read request(s) from the range 160c. At step 203, the node 120c may send the read data to the node 120b. The node 120c may send the read data to node 120b based on the node 120b being the gateway node for the read transaction. The node 120b may receive the read data from node 120c. At step 204, the node 120b may send the read data to the client device 106a to complete the read transaction. If node 120b had been configured to include the leaseholder for the range 160c, the node 120b may have served the read data to the client device directly after step 201, without routing the read request(s) of the read transaction to the node 120c.

### Write Transaction Execution

Referring to FIG. 2B, an example of execution of a write transaction including at least one write request at the computing system 100 is presented. In some cases, as described herein, the nodes 120a, 120b, and 120c, of region 110a may include one or more replicas of ranges 160. The node 120a may include replicas of ranges 160a, 160b, and 160c, where ranges 160a, 160b, and 160c are different ranges. The node 120a may include the leaseholder replica and the leader replica for range 160a (as indicated by “Leaseholder” in FIG. 2A and “Leader” in FIG. 2B). The node 120b may include replicas of ranges 160a, 160b, and 160c. The node 120b may include the leader replica for range 160b (as indicated by “Leader” in FIG. 2B). The node 120c may include replicas of ranges 160a, 160b, and 160c. The node 120c may include the leader replica for range 160c (as indicated by “Leader” in FIG. 2B). While FIG. 2B is described with respect to communication between nodes 120 of a single region (e.g., region 110a), a write transaction may operate similarly between nodes 120 located within different geographic regions.

In some embodiments, a client device 106 may initiate a write transaction at a node 120 of the cluster 102. Based on the KVs indicated by the write transaction, the node 120 that initially receives the write transaction (e.g., the gateway node) from the client device 106 may route write request(s) of the write transaction to a leaseholder of the range 160 comprising the KVs indicated by the write transaction. The leaseholder of the range 160 may route the write request(s) to the leader replica of the range 160. In most cases, the leaseholder of the range 160 and the leader replica of the range 160 are the same. The leader replica may append the write request(s) to a Raft log of the leader replica, write intent(s) corresponding to the write request(s), and may send the write request(s) to the corresponding follower replicas of the range 160 for replication. Follower replicas of the range may append the write request(s) to their corresponding Raft logs, write intent(s) corresponding to the appended write request(s), and send an indication to the leader replica that the write request(s) were appended. Based on a threshold number (e.g., a majority) of the replicas indicating and/or sending an indication to the leader replica that the write request(s) were appended, the write transaction may be committed by the leader replica. The leader replica may send an indication to the follower replicas to commit the write request(s) and the write transaction. The leader replica may send an acknowledgement of a commit of the write request(s) and the write transaction to the gateway node. The gateway node may send the acknowledgement to the client device 106.

As shown in FIG. 2B, at step 211, the client device 106 may send a write transaction to the cluster 102. The write transaction may be received by node 120c as the gateway node. The write transaction may be directed to data stored by the range 160a. At step 212, the node 120c may route write request(s) of the received write transaction to node 120a. The write transaction may be routed to node 120a based on the node 120a being the leaseholder of the range 160a. Based on the node 120a including the leader replica for the range 160a, the leader replica of range 160a may append the write request(s) to a Raft log at node 120a. At step 213, the leader replica may simultaneously send the write request(s) to the follower replicas of range 160a on the node 120b and the node 120c. The node 120b and the node 120c may append the write request(s) to their respective Raft logs. At step 214, the follower replicas of the range 160a (at nodes 120b and 120c) may send an indication to the leader replica of the range 160a that the write request(s) were appended to their Raft logs. Based on a threshold number of replicas indicating the write request(s) were appended to their Raft logs, the leader replica and follower replicas of the range 160a may commit the write request(s) and the write transaction. At step 215, the node 120a may send an acknowledgement of the committed write transaction to the node 120c. At step 216, the node 120c may send the acknowledgement of the committed write transaction to the client device 106a to complete the write transaction.

### Variably Scoped Read Snapshots

In some embodiments, as described herein and to implement MVCC, KVs of ranges stored by nodes (e.g., nodes 120) of the cluster (e.g., cluster 102) may be versioned. Each KV pair included in a range may be versioned with a respective timestamp. A particular key of a KV pair may have multiple stored versions, where each of the versions of the key has a different timestamp. In some cases, to implement MVCC, a transaction may read a KV stored by a node at a particular read timestamp that is defined by the transaction's read snapshot. When the transaction reads a particular key, the transaction may read and return a value mapped to the version (e.g., most recent version) of the key having the largest timestamp that is less than or equal to the transaction's read timestamp. In some cases, to implement MVCC, when a transaction operating on one or more KVs stored by a node commits, all write requests included in the transaction are committed at the same, commit timestamp. The commit timestamp (i) may or may not be equal to the transaction's read timestamp, and (ii) may never be less than the transaction's read timestamp. Transactions of several isolation levels (e.g., a read committed isolation level, snapshot isolation level, and a serializable isolation level) may adhere to the above-described parameters for implementing MVCC.

In some cases, for different isolation levels, one or more transactional properties can differ. In some cases, a particular isolation level can permit or prohibit a write skew anomaly. In some cases, a write skew anomaly may be defined by whether an isolation level allows a transaction to commit at a commit timestamp greater than a read timestamp of the transaction. An isolation level that prohibits write skew anomalies may only allow a transaction to commit at a commit timestamp that is equal to the transaction's read timestamp. Further, in some cases, a particular isolation level can permit or prohibit a transaction from using multiple read snapshots. An isolation level that prohibits a transaction from using multiple read snapshots may allow the transaction to use only one read snapshot (e.g., a per-transaction read snapshot scope). An isolation level that permits a transaction to use multiple read snapshots may allow the transaction to use one read snapshot per statement included in the transaction (e.g., a per-statement read snapshot scope). Parameters for write skew tolerance and read snapshot scope for multiple isolation levels are described summarized by Table 1.

TABLE 1
Operational Framework for Isolation Levels

| Isolation Level | Write Skew Tolerance | Read Snapshot Scope |
|---|---|---|
| Serializable | No | Per-Transaction |
| Snapshot | Yes | Per-Transaction |
| Read Committed | Yes | Per-Statement |

As described by Table 1, a serializable isolation level may not tolerate write skew anomalies, while snapshot and read committed isolation levels may tolerate write skew anomalies. Further, serializable and snapshot isolation levels may permit a per-transaction read snapshot scope, while a read committed isolation level may permit a per-statement read snapshot scope. Based on the framework described by Table 1, a particular isolation level may or may not permit particular anomalies to occur when applied to a transactional database. A serializable isolation level may not permit a write skew anomaly, a phantom read anomaly (e.g., when a transaction retrieves and reads a set of rows twice and new rows are inserted into or removed from that set by another transaction that is committed in between), or any other serialization anomaly. A snapshot isolation level may (i) provide repeatable reads, (ii) tolerate lost update anomalies, and (ii) be susceptible to write skew. A read committed isolation level may not provide repeatable reads and may tolerate lost update anomalies across multiple statements of a transaction. A read committed isolation level may not tolerate lost update anomalies within a single statement of a transaction.

In conventional transactional database systems, a transaction's read snapshot can be synonymous with the transaction's read timestamp. When a transaction establishes a new read snapshot, the transaction can select a read timestamp at which to read a version of a key. If the selected read timestamp needs to change (e.g., be advanced) based on a transaction conflict as described herein, the read snapshot scope can be aborted and retried with a new read timestamp. However, aborting and retrying the transaction includes several deficiencies as described herein. Accordingly, the improved techniques for data-dependent read snapshots can retain the meaning of a consistent read snapshot, while enabling adjustment to a transaction's read timestamp within a read snapshot.

### Transaction Conflicts

In some embodiments, as described herein, transactional conflicts can occur during execution of read operations (e.g., read requests) and/or write operations (e.g., write requests) of different transactions. An isolation conflict between transactions can occur which, if ignored, can lead to anomalies prohibited by the isolation level of the database on which the transactions operate. An example of an isolation conflict is a write/write conflict, where two concurrent transactions can both attempt to execute a write request for the same key of a range (e.g., stored by a node). In some cases, a node storing the key and the range may detect the write/write conflict when a transaction attempts to write a new version to a key (e.g., as a part of an UPDATE statement, a DELETE statement, or related mutation statement included in a transaction). In some cases, a node storing the key and the range may detect the write/write conflict when a transaction attempts to acquire a lock on the key (e.g., as a part of a SELECT FOR UPDATE statement or SELECT FOR SHARE statement). Before writing a new version to the key and/or acquiring a lock on the key, the transaction may identify the most recent version of the key and a timestamp (e.g., commit timestamp) of the most recent version of the key. The transaction may compare the timestamp of the most recent version of the key to the read timestamp of the transaction to determine whether the timestamp of the most recent version of the key is greater than or equal to the read timestamp of the transaction. When the timestamp of the most recent version of the key is greater than or equal to the read timestamp of the transaction, the transaction can detect a write/write conflict. When the timestamp of the most recent version of the key is less than the read timestamp of the transaction, the transaction does not detect a write/write conflict and may proceed to write a new version of the key. When committed, the newly written version of the key may have a commit timestamp equal to the read timestamp of the transaction.

In some embodiments, the comparison of the timestamp of the most recent version of the key to the read timestamp of the transaction may be needed particularly for instances where the transaction has previously read KVs at the read timestamp for the transaction's current read snapshot scope. When the timestamp of the most recent version of the key is greater than or equal to the read timestamp of the transaction, if the transaction were allowed to write a new version of the key, a lost update anomaly could occur such that the new version of the key overwrites the most recent version of the key (e.g., without the writer of the most recent version of the key being made aware of the transaction). When the transaction detects a write/write conflict (e.g., by the comparison described herein), the node on which the transaction operates may generate an error (referred to herein as a “write-too-old error”) indicating that the write request is outdated. The write-too-old-error may be returned to a client device from which the transaction originated when the write-too-old-error is not mitigated using a read refresh operation as described herein.

Another example of an isolation conflict is a read/write conflict, where a first transaction can write to a key of a range (e.g., stored by a node) after a concurrent, second transaction has read from the key (e.g., where the read timestamp of the second transaction is recorded by a timestamp cache). When the first transaction attempts to write to the key at a timestamp less than or equal to the read timestamp at which the second transaction previously read a version of the key, the timestamp of the first transaction may be advanced to a later timestamp that is greater than the read timestamp. The first transaction's timestamp may be advanced to the later timestamp based on a comparison of the timestamp with the most recent timestamp at which the key was read (e.g., stored by the timestamp cache). Based on advancing the timestamp to the later timestamp, the first transaction may write to the key and commit at a commit timestamp greater than or equal to the later timestamp (e.g., based on an abort and retry of the first transaction). For read committed and snapshot isolation levels, a read/write conflict may be allowable based on write skew tolerance and the first transaction may commit at a commit timestamp greater than or equal to the later timestamp when the commit timestamp is greater than the read timestamp of the first transaction. For a serializable isolation level, the read/write conflict can potentially prevent the first transaction from committing at the later timestamp based on the serializable isolation level requiring a commit timestamp of the first transaction to be equal to the read timestamp of the first transaction. For the serializable isolation level, if the first transaction fails to eventually commit because a commit timestamp of the first transaction will be greater than the read timestamp of the first transaction, the node on which the first transaction operates may generate an error (referred to herein as a “serializable-retry error”) requiring the first transaction to abort and retry (e.g., at the later timestamp). The serializable-retry error may be returned to a client device from which the first transaction originated when the serializable-retry error is not mitigated using a read refresh operation as described herein.

Another example of an isolation conflict is a write/read conflict, where a read request of a first transaction can attempt to read a key of a range (e.g., stored by a node) at a read timestamp that is greater than or equal to a timestamp of an uncommitted write intent written to the key by a concurrent, second transaction. The read request of the first transaction may wait for the write intent to be committed to the range or the read request may cause the second transaction to advance the timestamp of the write intent to be greater than the read timestamp of the read request (e.g., based on the first transaction having a higher priority than the second transaction). To cause the second transaction to advance the timestamp of the write intent to be greater than the read timestamp of the read request, the read request may provide an indication to the second transaction (e.g., to the transaction coordinator for the second transaction and/or to the write intent written by the second transaction) that the second transaction may only commit at a timestamp greater than the timestamp of the read request. Based on the second transaction receiving the indication from the read request, the read request of the first transaction may advance the timestamp of the write intent to a later timestamp that is greater than the read timestamp of the read request. When the read request of the first transaction advances the timestamp of the write intent to the later timestamp that is greater than the read timestamp of the read request, the read request may execute and read the value of the version (e.g., most recent version) of the key having the largest timestamp that is less than or equal to the read timestamp. The read timestamp may be recorded in a timestamp cache as described herein. After execution of the read request of the first transaction, the second transaction may attempt to commit at the later timestamp of the uncommitted write intent. In some cases, the second transaction's timestamp may be advanced to the later timestamp based on a comparison of the timestamp with the most recent timestamp at which the key was read (e.g., stored by the timestamp cache). The second transaction may commit at a commit timestamp greater than or equal to the later timestamp. For read committed and snapshot isolation levels, a write/read conflict may be allowable based on write skew tolerance and the second transaction may commit at a commit timestamp greater than or equal to the later timestamp when the commit timestamp is greater than the read timestamp of the second transaction. For a serializable isolation level, the write/read conflict can potentially prevent the second transaction from committing at the later timestamp based on the serializable isolation level requiring a commit timestamp of the second transaction to be equal to the read timestamp of the second transaction. For the serializable isolation level, when a commit timestamp of the second transaction will not be equal to the read timestamp of the second transaction, the second transaction can fail to commit and the node on which the second transaction operates may generate a serializable-retry error requiring the second transaction to abort and retry (e.g., at the later timestamp). The serializable-retry error may be returned to a client device from which the second transaction originated when the serializable-retry error is not mitigated using a read refresh operation as described herein. In some cases, read/write and write/read conflicts may not cause a serializable-retry error and an abort and retry for a transaction that adheres to a read committed isolation level.

In some cases, a consistency conflict can occur between concurrent transactions which, if ignored, would permit a transaction to violate real-time ordering guarantees of the distributed database system. An example of a consistency conflict is a read uncertainty conflict, where a read request of a transaction reads from a key at a particular read timestamp and observes a version of the key having a timestamp that is (i) greater than the read timestamp and (ii) within an uncertainty interval of the transaction (or statement of the transaction). In such cases, the transaction cannot determine whether the version of the key was or was not committed before the transaction began. To ensure read-after-write consistency, the transaction must (i) assume that the version of the key committed before the transaction began and (ii) observe the version of the key. However, because the version of the key has a timestamp greater than the transaction's read timestamp, observing the version of the key may compromise the integrity of the transaction's consistent read snapshot as it relates to the values of other keys which were previously observed to have no version with a timestamp greater than the read timestamp. Accordingly, based on a read uncertainty conflict, the node on which the transaction operates may generate an error (referred to herein as a “read-within-uncertainty-interval error”) that can cause the transaction to abort and retry with a new read snapshot and corresponding read timestamp. The read-within-uncertainty-interval error may be returned to a client device from which the transaction originated when the read-within-uncertainty-interval error is not mitigated using a read refresh operation as described herein.

### Data-Dependent Read Snapshots

In some embodiments, read refreshing as described herein may provide transactions including at least one read request with flexibility to adjust their read timestamp without (i) restarting the current read snapshot scope of the respective transaction and (ii) establishing a new read snapshot. An adjustment to a read timestamp of a transaction may be made based on (e.g., in response to) conflicts involving the transaction. Accordingly, the read snapshots may be data-dependent, such that the read snapshots adapt to the data that their transaction encounters in the cluster (e.g., cluster 102) based on the transaction's constituent read and/or write requests.

In some embodiments, as described herein, a transaction coordinator may operate on a gateway node that receives a transaction from a client device (e.g., client device 106). To implement data-dependent read snapshots, for a transaction including at least one read request (e.g., reading at least one KV stored by a range), a read timestamp may be assigned to the transaction (e.g., when not already specified by the transaction) and the transaction coordinator may generate (e.g., initialize) a list (referred to as a “refresh span list”) that uniquely corresponds to the transaction (or an individual statement of the transaction). The refresh span list may be stored on the gateway node on which the transaction coordinator operates. The refresh span list may be configured to indicate (e.g., track and record) each of the individual keys and/or contiguous key spans read by a particular transaction (e.g., for a per-transaction read snapshot scope) and/or a particular statement of a transaction (e.g., for a per-statement read snapshot scope) originating from the client device. As values of keys and/or key spans are read by a transaction and returned to the transaction coordinator at the gateway node, the transaction coordinator may record indications of the read keys and/or key spans in the refresh span list, such that the refresh span list identifies the keys and/or key spans read by the transaction. For a per-statement read snapshot scope (e.g., corresponding to a read committed isolation level), the key and/or key spans identified in a refresh span list may be deleted after each statement of a transaction is completed, such that the refresh span list only identifies key and/or key spans read by an individual statement of the transaction that is currently executing. A key span may be defined by a contiguous group of keys represented as [start-key-string, end-key-string), where “start-key-string” refers to a starting key of the key span and “end-key-string” refers to an end key of the key span. A key span may include all keys spanning the starting key of the key span and the end key of the key span. In some cases, a key span may span one or more ranges stored by nodes of the cluster. Keys stored by ranges may be sorted using any suitable sorting technique (e.g., numerically, alphabetically, alphanumerically, chronologically, etc.).

In some embodiments, when a transaction is received by a gateway node of the cluster, the gateway node may (i) assign a timestamp to the transaction (or statement of the transaction) and (ii) send read requests and/or write requests included in the transaction (e.g., derived from the statements of the transaction) to leaseholder(s) of the range(s) to be read from and/or written to by the transaction. In some cases, when the leaseholder replica of a range is not a leader replica of the range, the leaseholder replica may send a write request for the transaction to the leader replica of the range to which the write request is directed as described herein. At the leaseholder, based on receiving a read request of the transaction and when a read request of the transaction reads a version of a key and/or versions of keys included in a key span, the node that serves the read request may send an indication of the key(s) read by the request to the gateway node. The gateway node may receive an indication of the key(s) and/or key span(s) read by the transaction (e.g., along with the read value(s) of the key(s)) and the gateway node may append the indication of the key(s) and/or key span(s) to the refresh span list.

In some embodiments, as described herein, a request of a first transaction corresponding to a particular statement of the transaction may encounter a conflict with a second transaction based on a read timestamp of the first transaction, such as a write/write conflict, a read/write conflict, a write/read conflict, and a read uncertainty conflict. In some cases, the first transaction (or an individual statement of the first transaction) can be required to abort and retry at an advanced, later timestamp greater than or equal to a conflicting timestamp based on encountering a conflict. As a part of data-dependent read snapshots, based on the conflict corresponding to the first transaction, the node (e.g., leaseholder node and/or leader node) on which the request executes may determine a “refresh timestamp” (also referred to as a “refresh_timestamp”) for the first transaction. The refresh timestamp may be a minimum read timestamp at which the first transaction can avoid the conflict with the second transaction (e.g., avoid aborting and retrying the first transaction). In some cases, the refresh timestamp may be selected based on a type of conflict corresponding to the first transaction. For a write/write conflict corresponding to the first transaction, when a timestamp of a most recent version of a key to be written to by the first transaction is greater than or equal to a read timestamp of the first transaction, the refresh timestamp may be made greater than the timestamp of the most recent version of the key. For a read/write conflict corresponding to the first transaction, when the first transaction attempts to write to a key of a range (e.g., stored by a node) at a timestamp less than or equal to a read timestamp of the second transaction (e.g., where the read timestamp of the second transaction is recorded by a timestamp cache), the refresh timestamp may be made greater than the read timestamp of the second transaction. For a write/read conflict corresponding to the first transaction, when a second transaction advances a timestamp of a write intent of the first transaction to a later timestamp that is greater than a read timestamp of the second transaction (e.g., stored by a node), the refresh timestamp may be made greater than the read timestamp of the second transaction (e.g., equal to the later timestamp of the write intent of the first transaction). For a read uncertainty conflict corresponding to the first transaction, when the first transaction attempts to read a key at a read timestamp and observes a more recent version of the key having a timestamp that is (i) greater than the read timestamp and (ii) within an uncertainty interval of the first transaction, the refresh timestamp may be made equal to the timestamp of the more recent version of the key. In some cases, an advanced timestamp for a transaction (or statement of the transaction) and/or the refresh timestamp may be determined based on (e.g., to be equal to) a time indicated by a clock of a leaseholder node when the time indicated by the clock meets requirements between timestamps (e.g., greater than or equal to a particular timestamp).

In some embodiments, based on determining the refresh timestamp, the node (e.g., leaseholder node and/or leader node) may generate and send an error and an indication of the determined refresh timestamp to the gateway node that originally received the first transaction from the client device. In some cases, when the leaseholder for a range is not the leader replica for the range, the leader node may send the error and the indication of the determined refresh timestamp to the gateway node (e.g., via the leaseholder node). Accordingly, a function of the refresh timestamp can be to update the read timestamp of the first transaction to the later, refresh timestamp to avoid the conflict corresponding to the first transaction without invalidating the current read snapshot corresponding to the first transaction. The techniques described herein can determine whether all previously served read requests at the read timestamp for the first transaction would return identical results (e.g., read values) if the first transaction instead used the later, refresh timestamp for its read snapshot. Based the gateway node receiving the error and the indication of the determined refresh timestamp from the leaseholder node, the gateway node may generate and send a respective refresh request for each key and/or key span identified by the refresh span list stored by the gateway node. As an example, the gateway node may send a number of refresh requests corresponding to a number of keys and/or key spans identified by the refresh span list. A refresh request may include (i) an indication of the key or key span to which the refresh request is directed, (ii) a “refresh from timestamp” (also referred to as a “refresh_from_timestamp”) equal to the read timestamp of the first transaction, and (iii) the refresh timestamp. In some cases, the gateway node may send a number of refresh requests to a number of different ranges stored by nodes of the cluster based on the ranges storing keys and/or key spans identified by the refresh span list. In some cases, each refresh request may correspond to a distinct key or key span identified by the refresh span list.

In some embodiments, a node storing a key or key span of a range to which a refresh request is directed may receive the refresh request from the gateway node. The node that receives the refresh request may be a leaseholder node for the range. At the leaseholder node, the refresh request may read the key or key span and corresponding value(s) identified by the refresh request. Based on reading the key or key span, the refresh request may determine whether any of the read key or key span have timestamps that are both (i) greater than the refresh from timestamp and (ii) less than or equal to the refresh timestamp by comparing the timestamps of each version of the read key or keys in the read key span to the refresh from timestamp and refresh timestamp. When any versions of the read key or key span have timestamps that are both (i) greater than the refresh from timestamp and (ii) less than or equal to the refresh timestamp, the refresh request for the read key or key span may fail. When any of the refresh requests for the keys and/or key spans identified by the refresh span list fail, for a transaction having a per-transaction read snapshot scope, the first transaction may abort and retry execution with a new, updated timestamp that is greater than or equal to the refresh timestamp. When any of the refresh requests for the keys and/or key spans identified by the refresh span list fail, for a transaction having a per-statement read snapshot scope, the statement of the first transaction corresponding to the conflict may abort and retry execution with a new, updated timestamp that is greater than or equal to the refresh timestamp. When none of the read keys or key spans have timestamps that are both (i) greater than the refresh from timestamp and (ii) less than or equal to the refresh timestamp, the refresh request for the read key or key span may succeed. When each of the refresh requests for the first transaction succeed, each of the refresh requests may record an entry in the timestamp cache stored by the node for the leaseholder of the range including the key or key span identified by the respective refresh request, where the entry records the refresh timestamp as the most recent timestamp at which the key or key span was read by a transaction. When each of the refresh requests for the first transaction succeed, the read timestamp for the first transaction may be updated to be equal to the refresh timestamp. Based on updating the read timestamp for the first transaction to the refresh timestamp, the first transaction may proceed with executing the request for which the conflict was detected (e.g., without aborting and retrying) and the first transaction may commit at the refresh timestamp (e.g., based on whether other statement(s) of the transaction observe a conflict). In some cases, the first transaction may commit at a timestamp greater than the refresh timestamp when one or more additional conflicts occur for requests of the first transaction. For example, the first transaction may observe a second conflict, and may be required to update the refresh timestamp for the first transaction to a second refresh timestamp that is greater than the first refresh timestamp. By updating the refresh timestamp to the second refresh timestamp, the transaction coordinator may send a number of second refresh requests to a number of different ranges stored by nodes of the cluster based on the ranges storing keys and/or key spans identified by the refresh span list.

The above-described techniques for updating the read timestamp of the first transaction to the refresh timestamp provides the specific advantage of mitigating the encountered conflict by allowing the first transaction (or an individual statement of the first transaction) to execute without aborting and retrying. As an example, for serializable and snapshot isolation levels, updating the read timestamp of the first transaction to the refresh timestamp can allow a transaction to execute without aborting and retrying. As another example, for a read committed isolation level, updating the read timestamp of the first transaction to the refresh timestamp can allow an individual statement of a transaction to execute without aborting and retrying. Such techniques thereby reduce transaction latency and increase throughput of the database stored by the cluster, while also reducing the amount of work performed by the system.

### Server-Side Refresh Optimization

In some embodiments, the above-described techniques for data-dependent read snapshots may be optimized for instances where a refresh span list for a transaction is empty and does not include any keys or key spans. In some cases, a refresh span list for a transaction may be empty based on the transaction not including read requests in part of the transaction (e.g., within statements towards the beginning of the transaction). In some cases, a refresh span list for a transaction may be empty when the transaction adheres to a read committed isolation level based on the transaction establishing a new read snapshot for each statement of the transaction, and thereby initializing an empty refresh span list at the beginning of each statement. For a read committed isolation level, a transaction can include statements that perform locking reads on stored data at the beginning of each statement before accumulating indications of any keys or key spans in a refresh span list, such that the optimization described herein can eliminate all instances of statement-level aborts and retries by the transaction.

In some embodiments, to optimize data-dependent read snapshots for instances where a refresh span list for a transaction (or an individual statement of a transaction) is empty, the transaction coordinator from which a transaction originates may append a value of a “can forward indicator” (also referred to as a “can_forward_indicator”) to transactional requests sent to nodes of the cluster. A value of the can forward indicator appended with a transactional request sent from the gateway node to nodes of the cluster may indicate whether a leaseholder node on which the request operates can update a read timestamp for the transaction (or the statement of the transaction) to a later, refresh timestamp without communicating with the gateway node (e.g., storing the refresh span list). When the transaction coordinator sends a request of a transaction to another node storing data to which the request is directed, the request (i) may include a true value when the refresh span list for the transaction is empty and (ii) may include a false value when the refresh span list is not empty and/or the request is directed to two or more ranges. In some cases, on the leaseholder node, based on a request of a transaction encountering a conflict (e.g., based on a read timestamp of the transaction) and determining the refresh timestamp as described herein, the leaseholder node may identify a value of the appended can forward indicator. Based on identifying the value of the can forward indicator and determining the value of the indicator is false, the leaseholder node may generate and send an error and an indication of the determined refresh timestamp to the gateway node that originally received the first transaction, such that the gateway node can send one or more refresh requests to nodes of the cluster as described herein. Based on determining the value of the indicator is true, the leaseholder node can proceed to update a read timestamp for the transaction to the later, refresh timestamp, the transaction may proceed with executing the request for which the conflict was detected (e.g., without aborting and retrying). Based on updating the read timestamp to the refresh timestamp, the leaseholder node may send the refresh timestamp to the transaction coordinator operating on the gateway node. The gateway node may receive the refresh timestamp from the leaseholder node and may cause the transaction to use the refresh timestamp for executing subsequent requests included in the transaction. In some cases, the transaction may commit at the refresh timestamp or may commit at a timestamp greater than the refresh timestamp as described herein.

### Refresh Span Condensing

In some embodiments, a refresh span list for a particular transaction or statement of a transaction can grow very large when the transaction or statement includes a large number of read requests. To avoid utilizing excess resources (e.g., volatile storage of a gateway node storing the refresh span list and network bandwidth), a size limit can be introduced and applied to refresh span lists for transactions, such that a refresh span list can have a maximum size (e.g., defined in bytes). In some cases, to avoid disabling data-dependent read snapshots altogether, keys and key spans included in a refresh span list may be condensed to enable the refresh span list to adhere to a maximum size requirement. When a key or key span is configured to be added to a refresh span list that will cause the refresh span list to exceed the maximum size, the gateway node storing the refresh span list may condense keys and/or key spans to maintain the size of the refresh span list below the maximum size requirement.

In some embodiments, condensing keys and key spans may include combining two or more keys and/or key spans of a refresh span list into a single key span that spans the entire key span between two or more keys and/or key spans, while including two or more keys and/or key spans. Accordingly, keys and/or key spans that were not previously included in the refresh span list may be added to the refresh span list as a part of the combined key span. For example, for keys in a key space that is sorted alphabetically, a first key span of keys “a” to “c” and a second key span of keys “e” to “g” can be combined into a third key span of keys “a” to “g”. Such a third key span includes all of the keys in the original first and second key spans, along with additional keys that were not included in the first and second key spans. In some cases, via techniques for condensing a refresh span list, key spans identified by refresh requests and sent to leaseholder nodes for the key spans can lose precision to enable a refresh span list to remain below the maximum size. In some cases, the techniques for condensing keys and/or key spans in the refresh span list can cause false positive refresh failures, where a read refresh for a transaction can fail based on an observation of a conflict at a key and/or key span that was not subject to the transaction, but included in the condensed key span. The techniques for condensing keys and/or key spans in the refresh span list may never cause false negative refresh failures, where a read refresh for a transaction can succeed based on failing to observe a conflict at a key and/or key span that was subject to the transaction.

### Exemplary Method for Controlling Execution of Conflicting Transactional Operations

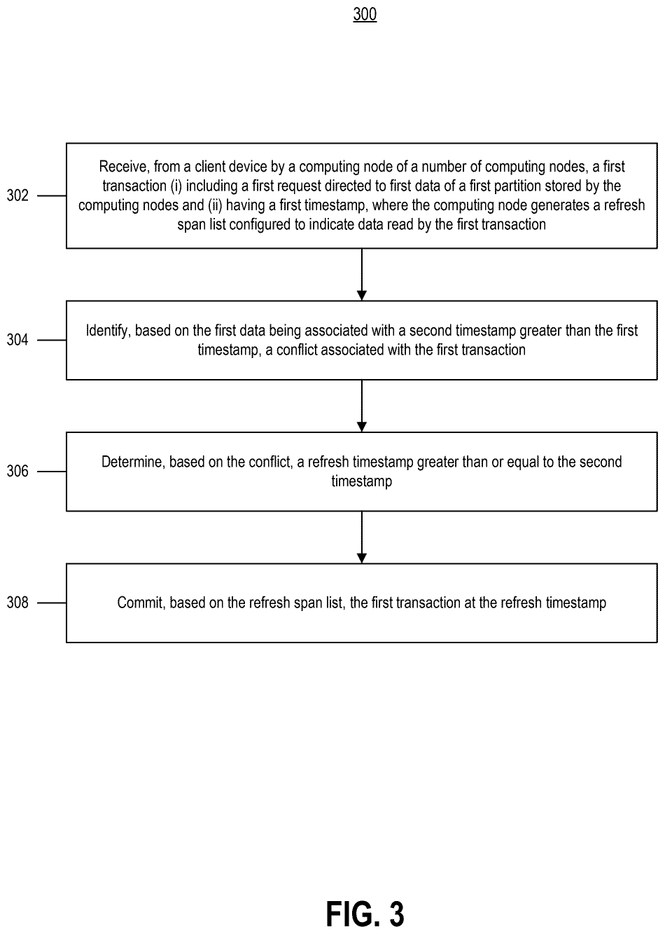

In some embodiments, as described herein, transaction conflicts can occur during execution of read requests and/or write requests of different transactions. A first request of a first transaction may encounter and conflict with a second request of a second transaction, thereby necessitating the first transaction use a new, updated read snapshot in place of a previous read snapshot used by the first transaction. To avoid the need to abort and retry a transaction or a statement of a transaction with an updated read snapshot (e.g., new read timestamp), a gateway node including a transaction coordinator may implement data-dependent read snapshots according to the techniques described herein by sending refresh requests for a transaction using a refresh timestamp and a refresh from timestamp. Referring to FIG. 3, an exemplary flowchart of a method 300 for controlling execution of conflicting transactional operations (e.g., corresponding to read requests and/or write requests) is illustrated. While the method 300 is described with respect to conflicts between operations of a first transaction including at least a first request and a second transaction directed to data stored by a nodes (e.g., nodes 120) of a cluster (e.g., cluster 102), the method 300 may be executed in parallel (e.g., simultaneously) by a number of nodes for a number of different transactions involving a number of requests directed to data, such as different KVs and/or ranges including KVs stored by the cluster. Transactions directed to reading from and/or writing to data stored by the cluster may originate from (e.g., be sent by) one or more client devices (e.g., client devices 106) communicatively connected to the cluster.

At step 302, a gateway node of a number of nodes forming a cluster may receive a first transaction from a client device. The gateway node may receive the first transaction from the client device via a network. In some cases, receiving the first transaction may include receiving an individual statement of the first transaction. The first transaction may include one or more statements. Based on a selected isolation level of the database stored by the cluster and including the data to which the first transaction is directed, the first transaction may adhere to an isolation level such as a read committed isolation level, a snapshot isolation level, or a serializable isolation level. All transactions directed to the same database may adhere to the same isolation level. The first transaction may include a first request directed to first data of at least a first partition (e.g., range) stored by the number of nodes. Based on receiving the first transaction, the gateway node may determine and assign a first timestamp to the first transaction and/or a statement of the first transaction based on the techniques described herein, such that the first transaction and/or the statement has the first timestamp assigned by the gateway node. As an example, the first timestamp may be equal to a time (e.g., HLC time defined by a clock operating on the gateway node) at which the gateway node received the first transaction and/or the statement of the first transaction from the client device. In some cases, based on receiving the first transaction, the gateway node may send requests of the first transaction to leaseholder nodes storing leaseholder replicas of ranges to which the requests are directed (e.g., to read and/or write) for execution. The first timestamp may be appended to requests sent to the leaseholder nodes. For example, based on receiving the first transaction, the gateway node may send the first request to each leaseholder node storing a leaseholder replica of a range to which the first request is directed.

In some embodiments, the first request of the first transaction may be a read request configured to read a most recent version of the first data that has a timestamp less than or equal to the first timestamp. Based on receiving the first transaction and determining the first request is a read request, the gateway note may (i) generate (e.g., initialize) a refresh span list configured to indicate data read by the first transaction or an individual statement of the first transaction and (ii) determine the first timestamp is a read timestamp for the first transaction and/or the statement of the first transaction (e.g., from which the first request is derived). In some cases, the first request of the first transaction may be configured to write a new version of the first data having (e.g., committed at) the first timestamp. To enable refresh requests to be sent to nodes storing data previously read by the first transaction, a transaction coordinator for the first transaction can be configured to record an indication of a version of data read by the first transaction and/or an individual statement of the first transaction in the refresh span list. As an example, the transaction coordinator for the first transaction may record indications of versions of all keys and/or key spans and corresponding values of the keys and/or key spans served (e.g., read and sent to the transaction coordinator) for the first transaction in the refresh span list during execution of the first transaction. As another example, the transaction coordinator for the first transaction may record indications of versions of all keys and/or key spans and corresponding values of the keys and/or key spans served (e.g., read and sent to the transaction coordinator) for an individual statement of the first transaction in the refresh span list during execution of the statement the first transaction. The data of the database stored by the cluster of nodes may be KV data included in partitions (e.g., ranges) as described herein, where the partitions may include a number of versions (e.g., MVCC versions) of the KV data.

At step 304, a leaseholder node to which the first request is sent may identify, based on the first data being associated with a second timestamp greater than the first timestamp, a conflict associated with the first transaction or an individual statement of the first transaction from which the first request is derived. The conflict may be a consistency conflict or an isolation conflict as described herein. In some cases, the first transaction can include a second request (e.g., corresponding to a same or different statement as the first request). The second request may be a read request configured to read a most recent version of second data of at least a second partition stored by the number of nodes that has a timestamp (e.g., a third timestamp) less than or equal to the first timestamp. In some cases, the second partition may be the same as or different from the first partition. The leaseholder node may store a leaseholder replica of the first partition. In some cases, the leaseholder replica may also be the leader replica for the first partition.

In some embodiments, for a write/write conflict, identifying the conflict can include determining the first data was written (e.g., committed) at the second timestamp (e.g., by a transaction different from the first transaction). Based on determining the first data was written at the second timestamp, the leaseholder node may compare the first timestamp to the second timestamp to determine the second timestamp is greater than or equal to the first timestamp. Based on determining the second timestamp is greater than or equal to the first timestamp, the leaseholder node may identify the conflict is a write/write conflict for the first transaction.

In some embodiments, for a read/write conflict, identifying the conflict can include determining the first data was read by a second transaction at the second timestamp (e.g., as indicated by a timestamp cache for the first data). To determine the first data was read by a second transaction at the second timestamp, the first request can evaluate a timestamp data structure (e.g., timestamp cache) stored by the leaseholder node to identify a most recent timestamp at which a version of the first data was read by a transaction. In some cases, the most recent timestamp at which a version of the first data was read by a transaction may be the second timestamp. Based on determining the first data was read by a second transaction at the second timestamp, the leaseholder node may compare the first timestamp to the second timestamp to determine the second timestamp is greater than or equal to the first timestamp. Based on determining the second timestamp is greater than or equal to the first timestamp, the leaseholder node may identify the conflict is a read/write conflict for the first transaction.

In some embodiments, for a write/read conflict, identifying the conflict can include writing, by the first request, the new version of the first data. The new version of the first data may be an uncommitted write intent having the first timestamp. A second transaction operating on the leaseholder node and having the second timestamp may identify the first timestamp of the new version of the first data. The second transaction may include a read request configured to read a most recent version of the first data having a timestamp (e.g., fourth timestamp) less than or equal to the second timestamp. Based on identifying the first timestamp of the new version of the first data, the leaseholder node may compare the first timestamp to the second timestamp to determine the second timestamp is greater than or equal to the first timestamp. Based on determining the second timestamp is greater than or equal to the first timestamp, the leaseholder node may identify the conflict is a write/read conflict for the first transaction. Based on identifying the conflict is a write/read conflict, the read request of the second transaction may cause the first timestamp of the new version of the first data and the corresponding second transaction to advance to a third timestamp that is greater than the second timestamp as described herein.

In some embodiments, for a read uncertainty conflict, identifying the conflict can include determining a version of the first data has the second timestamp and determining the second timestamp is both (i) greater than the first timestamp and (ii) within an uncertainty interval of the first transaction. Based on determining the second timestamp is both (i) greater than the first timestamp and (ii) within an uncertainty interval of the first transaction, the leaseholder node may identify the conflict is a read uncertainty conflict for the first transaction. As described herein, the uncertainty interval may be configured based on a maximum allowed timestamp difference (e.g., difference in time) between clocks operating on nodes of the cluster.

At step 306, the leaseholder node may determine, based on the conflict (e.g., a type of the conflict), a refresh timestamp greater than or equal to the second timestamp. In some cases, the refresh timestamp may be selected at the leaseholder node on which the conflict associated with the first transaction is observed and identified based on a type of the conflict. Based on a type of the conflict, the refresh timestamp may be determined and selected to be a minimum timestamp (e.g., read timestamp) at which the first transaction can avoid the conflict. Based on identifying the conflict is a write/write conflict, the leaseholder node may determine the refresh timestamp is greater than the second timestamp and may send the refresh timestamp to the transaction coordinator operating on the gateway node. Based on identifying the conflict is a read/write conflict, the leaseholder node may determine the refresh timestamp is greater than the second timestamp and may send the refresh timestamp to the transaction coordinator operating on the gateway node. Based on identifying the conflict is a write/read conflict, the leaseholder node may determine the refresh timestamp is greater than the second timestamp and may send the refresh timestamp to the transaction coordinator operating on the gateway node. The third timestamp may be equal to the refresh timestamp. Based on identifying the conflict is a read uncertainty conflict, the leaseholder node may determine the refresh timestamp is greater than or equal to the second timestamp and may send the refresh timestamp to the transaction coordinator operating on the gateway node.

At step 308, one or more nodes of the number of nodes may commit, based on the refresh span list (e.g., based on successful refresh requests derived from keys and/or key spans identified by the refresh span list), the first transaction at the refresh timestamp. The node(s) may commit the first transaction based on the determination of the refresh timestamp and sending one or more refresh requests. For example, the transaction coordinator operating on the gateway node for the first transaction may send a refresh request to each key and/or key span identified by the refresh span list, where each key and/or key span identified by the refresh span list was read and served by read requests of the first transaction (or an individual statement of the first transaction).

In some embodiments, the method 300 may further include one or more additional features. To avoid immediately aborting and retrying the first transaction or the statement of the first transaction from which the first request and/or second request is derived, based on the determination of the refresh timestamp, the leaseholder node may send (i) the refresh timestamp and (ii) an indication of the conflict to the transaction coordinator for the first transaction on the gateway node. The gateway node may receive the refresh timestamp and the indication of the conflict. Based on receiving the refresh timestamp and the indication of the conflict, the gateway node may analyze the refresh span list for the transaction to identify all keys and/or key spans that were previously read and served by read requests of the first transaction. Based on identifying all keys and/or key spans that were previously read and served by read requests of the first transaction, the gateway node may generate and send a refresh request to the leaseholder node of each key and key span recorded in the refresh span list. Each refresh request may include an indication of the key or key span to which it is directed, a refresh from timestamp (e.g., equal to the first timestamp, and the determined refresh timestamp.

In some embodiments, for each key and/or key span recorded in the refresh span list, the gateway node may generate and send a refresh request to the respective leaseholder node for the key or key span. The leaseholder node for the key or key span may receive the refresh request and may read the key or key span. Based on reading the key or key span, the leaseholder may determine whether any version of the key or key span has a timestamp that is (i) greater than the first timestamp or (ii) less than or equal to the refresh timestamp. When the leaseholder determines that any version of the key or key span has a timestamp that is (i) greater than the first timestamp or (ii) less than or equal to the refresh timestamp, the leaseholder may determine a failure of the refresh request for the respective key or key span. When the leaseholder determines that all versions of the key or key span have a timestamp that is (i) less than or equal to the first timestamp or (ii) greater than the refresh timestamp, the leaseholder may determine a success of the refresh request for the respective key or key span. When the refresh request for the key or key span succeeds, the leaseholder node may record an entry in the timestamp cache corresponding to the key or key span indicating the key or key span was read at the refresh timestamp. The leaseholder node may send an indication of a success or failure of the refresh request to the transaction coordinator on the gateway node. When the transaction coordinator receives indications of a failure of one or more the refresh requests for the first transaction (or the statement of the first transaction), the transaction coordinator may cause the first transaction (or the statement of the first transaction) to abort and retry at a new timestamp (e.g., greater than or equal to the second timestamp). When the transaction coordinator receives an indication of a success of each of the refresh requests for the first transaction (or the statement of the first transaction), the transaction coordinator may advance the first timestamp of the first transaction (or statement of the first transaction) to be equal to the refresh timestamp, thereby allowing the first transaction (or statement of the first transaction) to avoid the identified conflict without aborting and retrying.

In some embodiments, based on the transaction coordinator advancing the first timestamp of the first transaction (or statement of the first transaction) to be equal to the refresh timestamp, the first request may retry execution at the leaseholder node using the refresh timestamp in place of the original, first timestamp. The first request may read or write as described herein and requests of the first transaction may proceed to execute. In some cases, based on successful execution of all requests of the first transaction (or the statement of the first transaction), the first transaction may commit at the refresh timestamp. In some cases, other requests of the first transaction may encounter conflicts and require the read timestamp and/or commit timestamp of the first transaction to be advanced to be greater than the refresh timestamp.

In some embodiments, committing the first transaction at the refresh timestamp may include reading a most recent version of the first data having a timestamp less than or equal to the refresh timestamp and sending the read value to the client device. When the first request is configured to write a new version of the first data, committing the first transaction at the refresh timestamp may include writing the new version of the first data having the refresh timestamp, where the new version of the first data is committed to the partition (e.g., an MVCC value) and/or identified as committed by the transaction record for the first transaction. In some cases, for a read committed isolation level, a committed transaction may have a read timestamp that is less than a commit timestamp of the transaction. Other conditions for committing the first transaction may include those described herein, such as reading and writing all data subject to the request(s) of the transaction at a read timestamp and commit timestamp.

In some embodiments, to optimize data-dependent read snapshots for instances where a refresh span list for a transaction is empty, the transaction coordinator for the first transaction may append a value of a can forward indicator to transactional requests sent to nodes of the cluster. The first request may include the can forward indicator, where value (e.g., true or false) of the forward indicator is (i) selected based on the refresh span list as described herein and (ii) selected by the transaction coordinator operating on the gateway node. Based on determining the refresh timestamp and identifying the value of the can forward indicator included with the first request is true, the leaseholder node may proceed to advance the first timestamp of the first transaction (or statement of the first transaction) to be equal to the refresh timestamp. Based on determining the refresh timestamp and identifying the value of the can forward indicator included with the first request is false, the leaseholder node may execute operations to cause sending of refresh requests as described herein. The can forward indicator can have a first (e.g., false) value when the refresh span list indicates the first transaction has executed at least one read request. The can forward indicator can have a second (e.g., true) value when the refresh span list indicates the first transaction has not executed at least one read request.

### Further Description of Some Embodiments

FIG. 4 is a block diagram of an example computer system 400 that may be used in implementing the technology described in this document. General-purpose computers, network appliances, mobile devices, or other electronic systems may also include at least portions of the system 400. The system 400 includes a processor 410, a memory 420, a storage device 430, and an input/output device 440. Each of the components 410, 420, 430, and 440 may be interconnected, for example, using a system bus 450. The processor 410 is capable of processing instructions for execution within the system 400. In some implementations, the processor 410 is a single-threaded processor. In some implementations, the processor 410 is a multi-threaded processor. The processor 410 is capable of processing instructions stored in the memory 420 or on the storage device 430.

The memory 420 stores information within the system 400. In some implementations, the memory 420 is a non-transitory computer-readable medium. In some implementations, the memory 420 is a volatile memory unit. In some implementations, the memory 420 is a non-volatile memory unit.

The storage device 430 is capable of providing mass storage for the system 400. In some implementations, the storage device 430 is a non-transitory computer-readable medium. In various different implementations, the storage device 430 may include, for example, a hard disk device, an optical disk device, a solid-date drive, a flash drive, or some other large capacity storage device. For example, the storage device may store long-term data (e.g., database data, file system data, etc.). The input/output device 440 provides input/output operations for the system 400. In some implementations, the input/output device 440 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 460. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 430 may be implemented in a distributed way over a network, for example as a server farm or a set of widely distributed servers, or may be implemented in a single computing device.

Although an example processing system has been described in FIG. 4, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer-implemented method for controlling execution of conflicting transactional operations, the method comprising:
receiving, from a client device by a computing node of a plurality of computing nodes, a first transaction comprising (i) a first request directed to first data of a first partition stored by the plurality of computing nodes and (ii) a first timestamp, wherein the computing node generates a refresh span list configured to indicate data read by the first transaction;
identifying, based on the first data being associated with a second timestamp greater than the first timestamp, a conflict associated with the first transaction;
determining, based on the conflict, a refresh timestamp greater than or equal to the second timestamp; and
committing, based on the refresh span list, the first transaction at the refresh timestamp.

2. The method of claim 1, wherein the computing node assigns the first timestamp to the first transaction, wherein the first timestamp is equal to a time at which the computing node received the first transaction.

3. The method of claim 1, wherein the first request is configured to read a most recent version of the first data having a timestamp less than or equal to the first timestamp.

4. The method of claim 1, wherein the first request is configured to write a new version of the first data having the first timestamp.

5. The method of claim 1, wherein the computing node is configured to record an indication of a version of data read by the first transaction in the refresh span list.

6. The method of claim 1, wherein (i) the first data comprises key-value data and (ii) the first partition comprises a plurality of versions of the key-value data.

7. The method of claim 1, wherein the first transaction comprises a second request configured to read a most recent version of second data of a second partition stored by the plurality of computing nodes, the most recent version of the second data having a timestamp less than or equal to the first timestamp, wherein the first request is configured to write a new version of the first data having the first timestamp, wherein identifying the conflict associated with the first transaction comprises:
determining the first data was written at the second timestamp;
comparing the first timestamp to the second timestamp;
based on the second timestamp being greater than or equal to the first timestamp, identifying the conflict; and
determining, based on identifying the conflict, the refresh timestamp is greater than the second timestamp.

8. The method of claim 1, wherein the first transaction comprises a second request configured to read a most recent version of second data of a second partition stored by the plurality of computing nodes, the most recent version of the second data having a timestamp less than or equal to the first timestamp, wherein the first request is configured to write a new version of the first data having the first timestamp, wherein identifying the conflict associated with the first transaction comprises:
determining the first data was read by a second transaction at the second timestamp;
comparing the first timestamp to the second timestamp;
based on the second timestamp being greater than or equal to the first timestamp, identifying the conflict; and
determining, based on identifying the conflict, the refresh timestamp is greater than the second timestamp.

9. The method of claim 8, wherein a timestamp data structure indicates the first data was read by the second transaction at the second timestamp.

10. The method of claim 1, wherein the first transaction comprises a second request configured to read a most recent version of second data of a second partition stored by the plurality of computing nodes, the most recent version of the second data having a third timestamp less than or equal to the first timestamp, wherein the first request is configured to write a new version of the first data having the first timestamp, wherein identifying the conflict associated with the first transaction comprises:
writing, by the first request, the new version of the first data, wherein the new version of the first data is uncommitted;
identifying, by a second transaction, the first timestamp of the new version of the first data, wherein the second transaction comprises a third request configured to read a most recent version of the first data having a fourth timestamp less than or equal to the second timestamp;
comparing the first timestamp to the second timestamp;
based on the second timestamp being greater than or equal to the first timestamp, identifying the conflict; and
determining, based on identifying the conflict, the refresh timestamp is greater than the second timestamp.

11. The method of claim 1, wherein the first request is configured to read a most recent version of the first data having a timestamp less than or equal to the first timestamp, wherein identifying the conflict associated with the first transaction comprises:
determining a version of the first data has the second timestamp;
determining the second timestamp is (i) greater than the first timestamp and (ii) within an uncertainty interval of the first transaction;
based on the second timestamp being (i) greater than the first timestamp and (ii) within the uncertainty interval of the first transaction, identifying the conflict; and
determining, based on identifying the conflict, the refresh timestamp is greater than or equal to the second timestamp.

12. The method of claim 11, wherein the uncertainty interval is configured based on a maximum allowed timestamp difference between a plurality of clocks operated by the plurality of computing nodes.

13. The method of claim 1, further comprising:
sending, based on determining the refresh timestamp, (i) the refresh timestamp and (ii) an indication of the conflict to the computing node;
receiving, from the computing node based on the refresh span list, at least one refresh request comprising an indication of third data of a third partition stored by the plurality of computing nodes, wherein the first transaction previously read a most recent version of the third data having a third timestamp less than or equal to the first timestamp; and
updating the first timestamp to be equal to the refresh timestamp based on determining each version of the third data comprises a respective timestamp that is (i) less than or equal to the first timestamp or (ii) greater than the refresh timestamp.

14. The method of claim 13, further comprising:
committing, based on updating the first timestamp to be equal to the refresh timestamp, the first transaction at the refresh timestamp.

15. The method of claim 1, wherein the first request comprises an indicator comprising a value that is selected (i) based on the refresh span list and (ii) by the computing node, and further comprising:
updating, based on determining the refresh timestamp and a value of the indicator, the first timestamp to be equal to the refresh timestamp.

16. The method of claim 15, further comprising:
committing, based on updating the first timestamp to be equal to the refresh timestamp, the first transaction at the refresh timestamp.

17. The method of claim 16, wherein (i) the indicator has a first value when the refresh span list indicates the first transaction has executed at least one read request, and (ii) the indicator has a second value when the refresh span list indicates the first transaction has not executed any read request.

18. The method of claim 1, wherein committing the first transaction comprises reading a most recent version of the first data having a timestamp less than or equal to the refresh timestamp.

19. The method of claim 1, wherein (i) the first request is configured to write a new version of the first data, and (ii) committing the first transaction comprises writing the new version of the first data having the refresh timestamp.

20. A system for controlling execution of conflicting transactional operations, the system comprising:
a plurality of computing nodes configured to perform operations comprising:
receiving, from a client device by a computing node of the plurality of computing nodes, a first transaction comprising (i) a first request directed to first data of a first partition stored by the plurality of computing nodes and (ii) a first timestamp, wherein the computing node generates a refresh span list configured to indicate data read by the first transaction;
identifying, based on the first data being associated with a second timestamp greater than the first timestamp, a conflict associated with the first transaction;
determining, based on the conflict, a refresh timestamp greater than or equal to the second timestamp; and
committing, based on the refresh span list, the first transaction at the refresh timestamp.
